(19) United States
(12) Patent Application Publication
(10) Pub. No.: US 2025/0119593 A1
(43) Pub. Date: Apr. 10, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Junru LI, Beijing (CN); Kai ZHANG, Los Angeles, CA (US); Li ZHANG, Los Angeles, CA (US); Yue Li, Los Angeles, CA (US)

(21) Appl. No.: 18/986,675

(22) Filed: Dec. 18, 2024

Related U.S. Application Data
(63) Continuation of application No. PCT/CN2023/100271, filed on Jun. 14, 2023.

(30) Foreign Application Priority Data
Jun. 18, 2022 (WO) PCT/CN2022/099644

(51) Int. Cl. H04N 19/82; H04N 19/117; H04N 19/186; H04N 19/86

(52) U.S. Cl. CPC H04N 19/82; H04N 19/117; H04N 19/186; H04N 19/86

(57) ABSTRACT

Embodiments of the present disclosure provide a solution for video processing. A method for video processing is proposed. The method comprises: applying, for a conversion between a video unit of a video and a bitstream of the video, a connection to a plurality of filters; applying the plurality of filters with the connection in combination to the video unit; and performing the conversion based on the filtered video unit.

### CROSS-REFERENCE TO RELATED APPLICATIONS

This application is a continuation of International Application No. PCT/CN2023/100271, filed on Jun. 14, 2023, which claims the benefit of International Application No. PCT/CN2022/099644, filed on Jun. 18, 2022. The entire contents of these applications are hereby incorporated by reference in their entireties. FIELDS

Embodiments of the present disclosure relates generally to video processing techniques, and more particularly, to a combination of neural network (NN) based filters for image/video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: applying, for a conversion between a video unit of a video and a bitstream of the video, a connection to a plurality of filters;

applying the plurality of filters with the connection in combination to the video unit; and performing the conversion based on the filtered video unit. The method in accordance with the first aspect of the present disclosure combined the filters adaptively, which can advantageously improve the coding efficiency and performance.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: applying a connection to a plurality of filters; applying the plurality of filters with the connection in combination to a video unit of the video; and generating the bitstream based on the filtered video unit.

In a fifth aspect, a method for storing a bitstream of a video is proposed. The method comprises: applying a connection to a plurality of filters; applying the plurality of filters with the connection in combination to a video unit of the video; generating the bitstream based on the filtered video unit; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing an example of raster-scan slice partitioning of a picture;

FIG. 5 illustrates an example diagram showing an example of rectangular slice partitioning of a picture;

FIG. 6 illustrates an example diagram showing an example of a picture partitioned into tiles, bricks, and rectangular slices;

FIG. 7A illustrates an example diagram showing CTBs crossing the bottom picture border;

FIG. 7B illustrates an example diagram showing CTBs crossing the right picture border;

FIG. 7C illustrates an example diagram showing CTBs crossing the right bottom picture border;

FIG. 8 illustrates an example diagram showing an example of encoder block diagram;

FIG. 9 illustrates an example diagram showing an illustration of picture samples and horizontal and vertical block boundaries on the 8×8 grid, and the nonoverlapping blocks of the 8×8 samples;

FIG. 10 illustrates an example diagram showing pixels involved in filter on/off decision and strong/weak filter selection;

FIGS. 11A-11D illustrate example diagrams showing four 1-D directional patterns for EO sample classification;

FIGS. 12A-12C illustrate example diagrams showing examples of GALF filter shapes;

FIGS. 13A-13C illustrate example diagrams showing examples of relative coordinator for the 5×5 diamond filter support;

FIG. 14 illustrates an example diagram showing examples of relative coordinates for the 5×5 diamond filter support;

FIG. 15A illustrates an example diagram showing Architecture of the proposed CNN filter and FIG. 15B illustrates an example diagram showing a construction of ResBlock (residual block) in the CNN filter;

FIG. 16A to FIG. 16E illustrate schematic diagrams of filters with a connection according to embodiments of the present disclosure, respectively;

FIG. 17A and FIG. 17B illustrate schematic diagrams of samples according to embodiments of the present disclosure, respectively;

FIG. 18 illustrates a flowchart of a method for video processing in accordance with embodiments of the present disclosure; and

FIG. 19 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

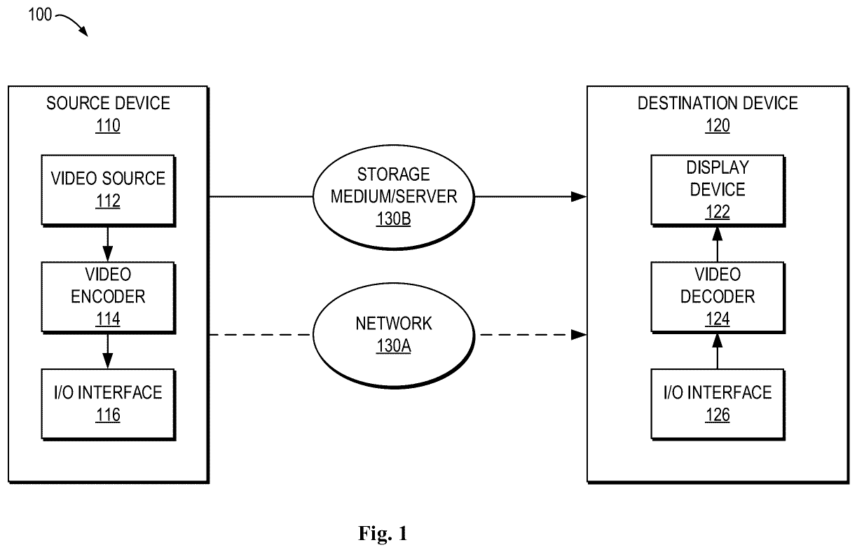

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

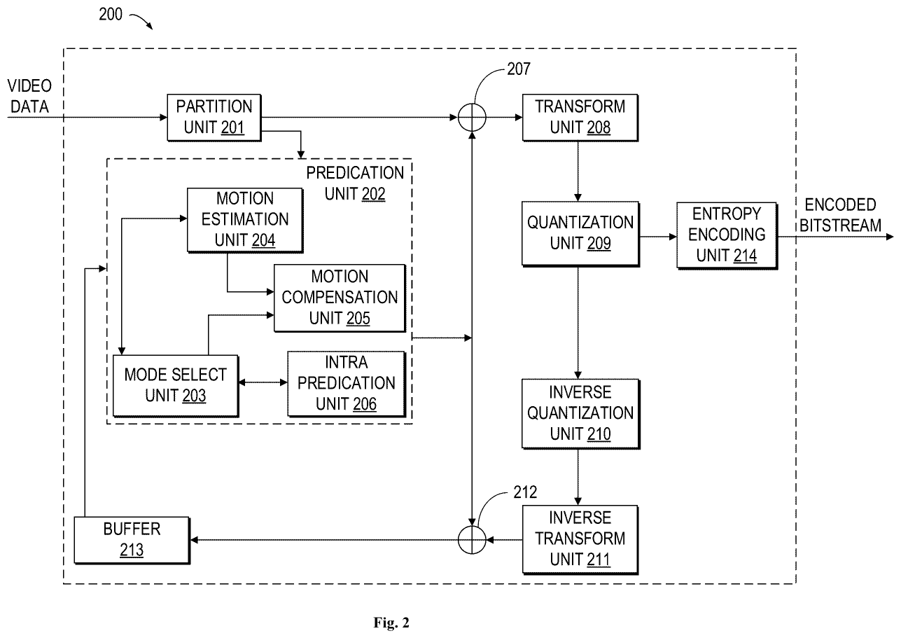

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

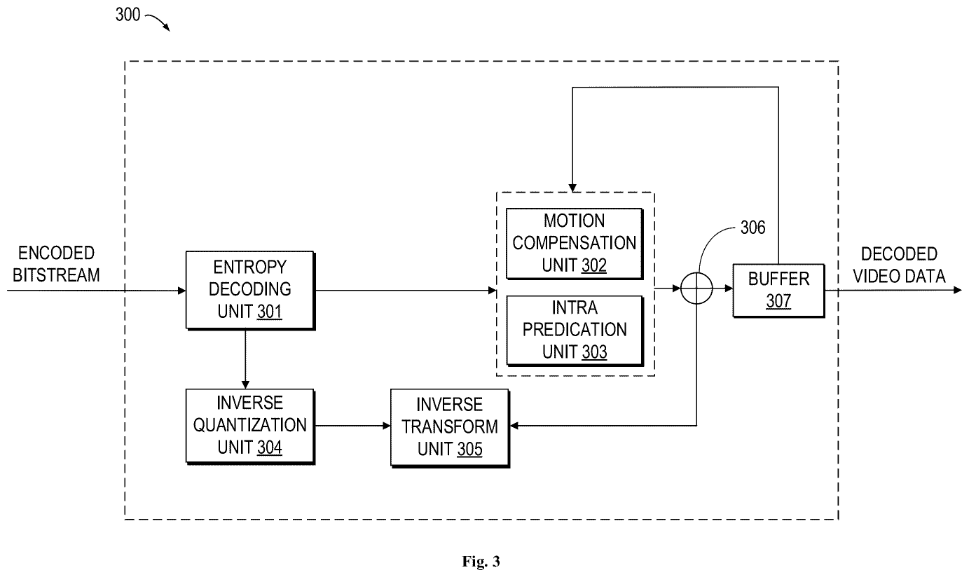

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is related to the loop filter in image/video coding. It may be applied to the existing video coding standard like High-Efficiency Video Coding (HEVC), Versatile Video Coding (VVC), or the standard (e.g., AVS3) to be finalized. It may be also applicable to future video coding standards or video codec or being used as post-processing method which is out of encoding/decoding process.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure where temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

The latest version of VVC draft, i.e., Versatile Video Coding (Draft 10) could be found at: http://phenix.it-sudparis.eu/jvet/doc_end_user/current_document.php?id=10399.

The latest reference software of VVC, named VTM, could be found at: https://vcgit.hhi.fraunhofer.de/jvet/VVCSoftware_VTM/-/tags/VTM-10.0.

### 2.1. Color Space and Chroma Subsampling

Color space, also known as the color model (or color system), is an abstract mathematical model which simply describes the range of colors as tuples of numbers, typically as 3 or 4 values or color components (e.g. RGB).

Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

The two chroma components are sampled at half the sample rate of luma: the horizontal chroma resolution is halved. This reduces the bandwidth of an uncompressed video signal by one-third with little to no visual difference.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

### 2.2. Definitions of Video Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains a number of tiles of a picture or a number of bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

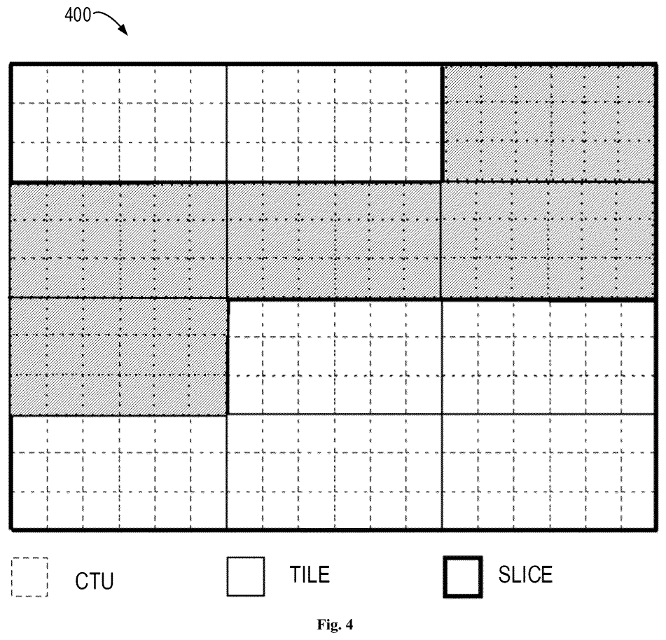

FIG. 4 illustrates an example diagram 400 showing an example of raster-scan slice partitioning of a picture. In FIG. 4, the picture is divided into 12 tiles and 3 raster-scan slices. The picture in FIG. 4 with 18 by 12 luma CTUs is partitioned into 12 tiles and 3 raster-scan slices (informative).

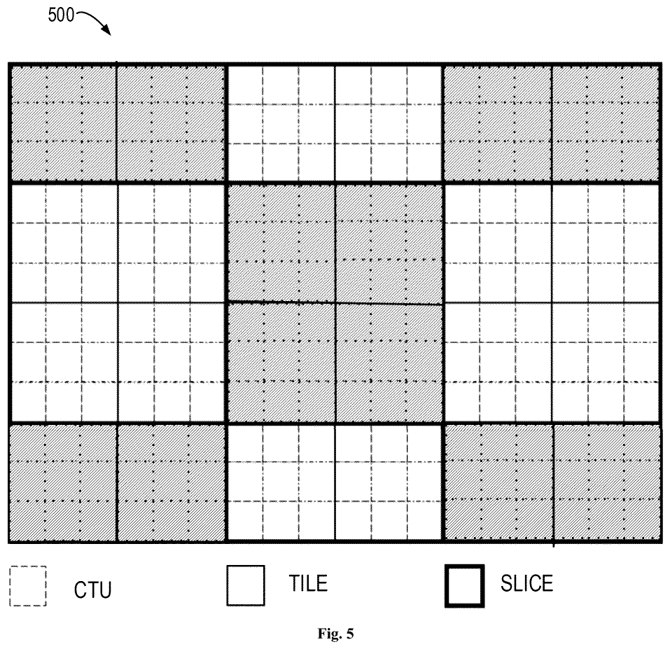

FIG. 5 illustrates an example diagram 500 showing an example of rectangular slice partitioning of a picture. In FIG. 5, the picture is divided into 24 tiles (6 tile columns and 4 tile rows) and 9 rectangular slices. The picture in FIG. 5 with 18 by 12 luma CTUs is partitioned into 24 tiles and 9 rectangular slices (informative).

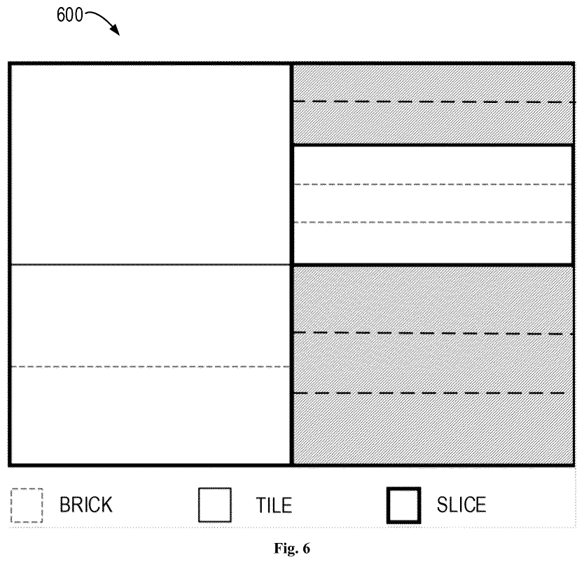

FIG. 6 illustrates an example diagram 600 showing an example of a picture partitioned into tiles, bricks, and rectangular slices. In FIG. 6, the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. The picture in FIG. 6 is partitioned into 4 tiles, 11 bricks, and 4 rectangular slices (informative).

### 2.2.1. CTU/CTB Sizes

In VVC, the CTU size, signaled in SPS by the syntax element log 2_ctu_size_minus2, could be as small as 4×4.

7.3.2.3 Sequence parameter set RBSP syntax

| seq_parameter_set_rbsp( ) { | Descriptor |
|---|---|
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < ! rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| . . . | |
| rbsp_trailing_bits( ) | |
| } | |

log 2_ctu_size_minus2 plus 2 specifies the luma coding tree block size of each CTU.

log 2_min_luma_coding_block_size_minus2 plus 2 specifies the minimum luma coding block size.

The variables CtbLog2SizeY, CtbSize Y, MinCbLog2SizeY, MinCbSizeY, MinTbLog2Size Y, MaxTbLog2SizeY, MinTbSizeY, MaxTbSizeY, PicWidthInCtbsY, PicHeightInCtbsY, PicSizeInCtbsY, PicWidthInMinCbsY, PicHeightInMinCbsY, PicSizeInMinCbsY, PicSizeInSamples Y, Pic WidthInSamplesC and PicHeightInSamplesC are derived as follows:

$$Ctb Log 2 SizeY = log 2 \_ctu \_size \_minus2 + 2 \qquad ( 7 - 9 )$$

$$CtbSizeY = 1 ≪ Ctb Log 2 SizeY \qquad ( 7 - 10 )$$

$$Min Cb Log 2 SizeY = log2\_min \_luma \_coding \_block \_minus2 + 2 \qquad ( 7 - 11 )$$

$$Min Cb SizeY = 1 ≪ Min Cb Log 2 SizeY \qquad ( 7 - 12 )$$

$$Min Tb Log 2 SizeY = 2 \qquad ( 7 - 13 )$$

$$Max Tb Log 2 SizeY = 6 \qquad ( 7 - 14 )$$

$$Min TbSizeY = 1 ≪ Min Tb Log 2 SizeY \qquad ( 7 - 15 )$$

$$Max TbSizeY = 1 ≪ Max Tb Log 2 SizeY \qquad ( 7 - 16 )$$

$$PicWidthInCtbsY = Ceil ( pic\_width \_in \_luma \_samples \div CtbSizeY ) \qquad ( 7 - 17 )$$

$$PicHeightInCtbsY = Ceil ( pic\_height \_in \_luma \_samples \div CtbSizeY ) \qquad ( 7 - 18 )$$

$$PicSizeInCtbsY = PicWidthInCtbsY * PicHeightInCtbsY \qquad ( 7 - 19 )$$

$$PicWidthIn Min CbsY = pic\_width \_in \_luma \_samples / Min CbSizeY \qquad ( 7 - 20 )$$

$$PicHeightIn MinCbsY = pic\_height \_in \_luma \_samples / Min CbSizeY \qquad ( 7 - 21 )$$

$$PicSizeIn Min CbsY = PicWidthIn Min CbsY * PicHeightIn Min CbsY \qquad ( 7 - 22 )$$

$$PicSizeInSamplesY = pic\_width \_in \_luma \_samples * pic\_height \_in \_luma \_samples \qquad ( 7 - 23 )$$

$$PicWidthInSamplesC = pic\_width \_in \_luma \_samples / SubWidthC \qquad ( 7 - 24 )$$

$$PicHeightInSamplesC = pic\_height \_in \_luma \_samples / SubHeightC \qquad ( 7 - 25 )$$

### 2.2.2. CTUs in a Picture

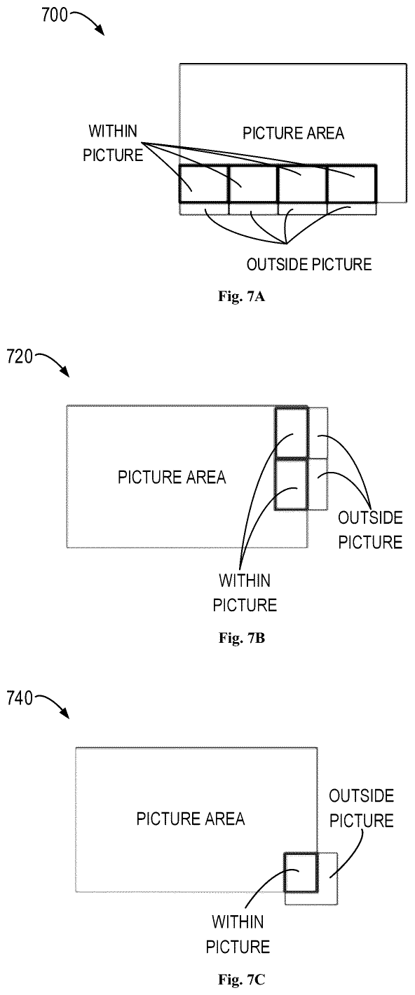

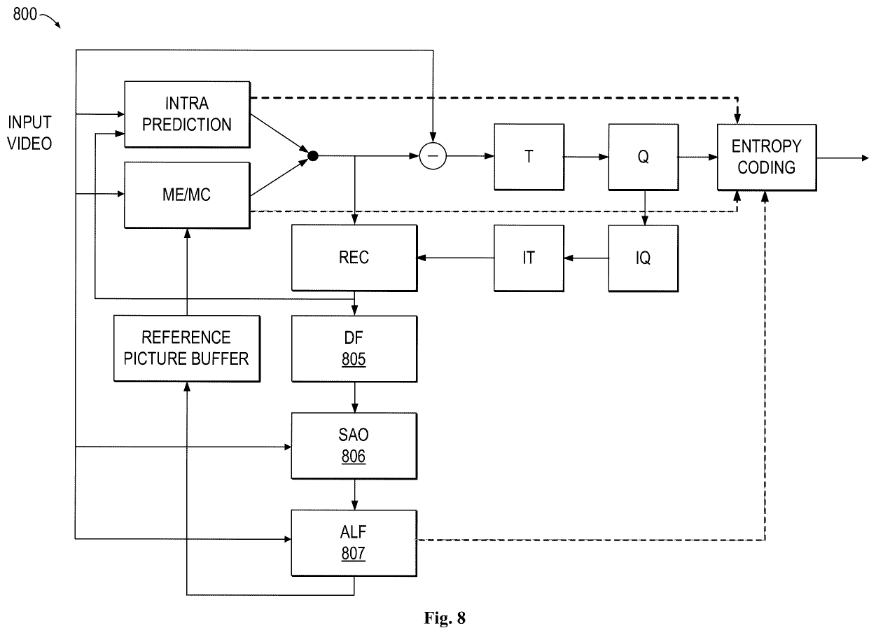

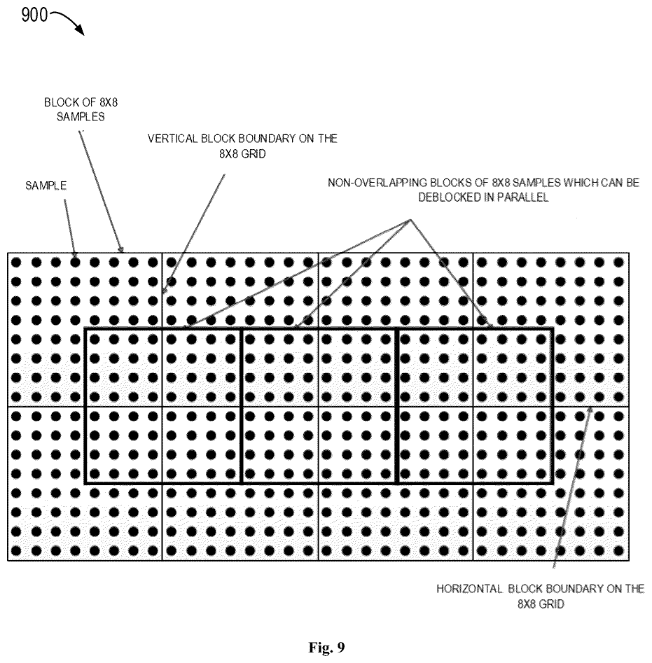

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border where either K<M or L<N. FIG. 7A illustrate an example diagram 700 showing CTBs crossing the bottom picture border, in which K=M, L<N. FIG. 7B illustrates an example diagram 720 showing CTBs crossing the right picture border, in which K<M, L=N. FIG. 7C illustrates an example diagram 740 showing CTBs crossing the right bottom picture border, in which K<M, L<N. For those CTBs as depicted in FIGS. 7A-7C, the CTB size is still equal to MxN, however, the bottom boundary/right boundary of the CTB is outside the picture.

### 2.3. Coding Flow of a Typical Video Codec

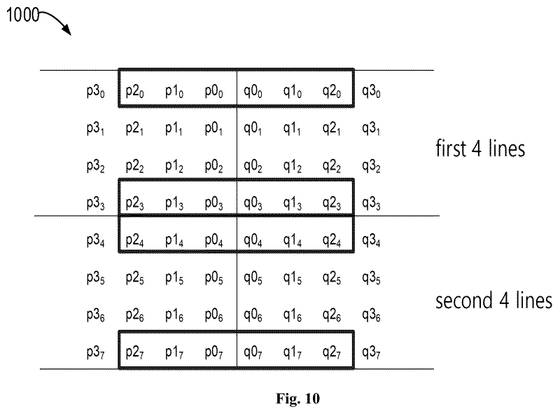

FIG. 8 illustrates an example diagram 800 showings an example of encoder block diagram of VVC, which contains three in-loop filtering blocks: deblocking filter (DF) 805, sample adaptive offset (SAO) 806 and ALF 807. Unlike DF 805, which uses predefined filters, SAO 806 and ALF 807 utilize the original samples of the current picture to reduce the mean square errors between the original samples and the reconstructed samples by adding an offset and by applying a finite impulse response (FIR) filter, respectively, with coded side information signaling the offsets and filter coefficients. ALF 807 is located at the last processing stage of each picture and can be regarded as a tool trying to catch and fix artifacts created by the previous stages.

### 2.4. Deblocking Filter (DB)

The input of DB is the reconstructed samples before in-loop filters.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

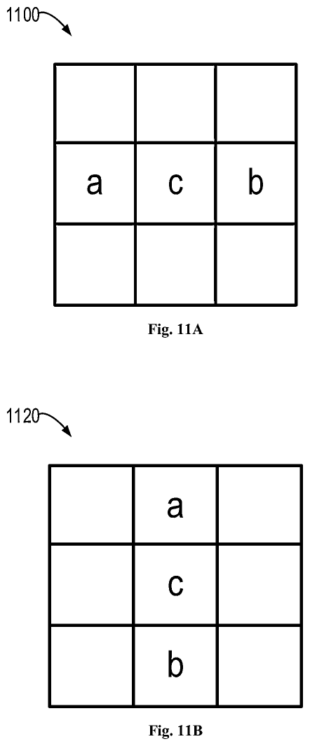

FIG. 9 illustrates an example diagram 900 showing an illustration of picture samples and horizontal and vertical block boundaries on the 8×8 grid, and the nonoverlapping blocks of the 8×8 samples, which can be deblocked in parallel.

### 2.4.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 2.4.2. Boundary Strength Calculation

For a transform block boundary/coding subblock boundary, if it is located in the 8×8 grid, it may be filterd and the setting of bS [xDᵢ] [yDⱼ] (where [xDᵢ] [yDⱼ] denotes the coordinate) for this edge is defined in Table 1 and Table 2, respectively.

TABLE 1
Boundary strength (when SPS IBC is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent blocks has non-zero transform | 1 | 1 | 1 |
| | coefficients | | | |
| 3 | Reference pictures or number of MVs (1 for uni-prediction, 2 for bi- | 1 | N/A | N/A |
| | prediction) of the adjacent blocks are different | | | |
| 2 | Absolute difference between the motion vectors of same reference picture | 1 | N/A | N/A |
| | that belong to the adjacent blocks is greater than or equal to one integer | | | |
| | luma sample | | | |
| 1 | Otherwise | 0 | 0 | 0 |

TABLE 2
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent blocks has non-zero transform | 1 | 1 | 1 |
| | coefficients | | | |
| 6 | Prediction mode of adjacent blocks is different (e.g., one is IBC, one is | 1 | | |
| | inter) | | | |
| 5 | Both IBC and absolute difference between the motion vectors that belong | 1 | N/A | N/A |
| | to the adjacent blocks is greater than or equal to one integer luma sample | | | |
| 4 | Reference pictures or number of MVs (1 for uni-prediction, 2 for bi- | 1 | N/A | N/A |
| | prediction) of the adjacent blocks are different | | | |
| 3 | Absolute difference between the motion vectors of same reference picture | 1 | N/A | N/A |
| | that belong to the adjacent blocks is greater than or equal to one integer | | | |
| | luma sample | | | |
| 1 | Otherwise | 0 | 0 | 0 |

### 2.4.3. Deblocking Decision for Luma Component

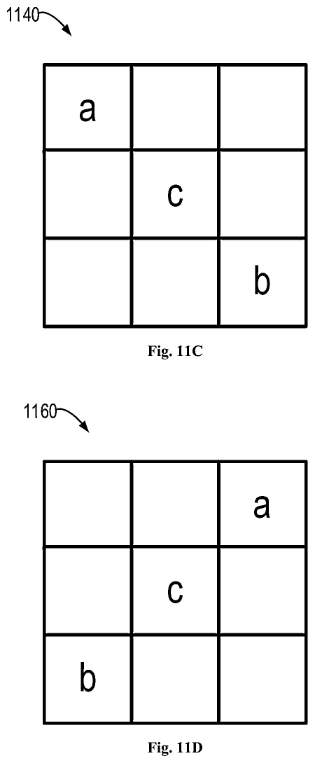

The deblocking decision process is described in this sub-section. FIG. 10 illustrates an example diagram 1000 showing pixels involved in filter on/off decision and strong/weak filter selection.

Wider-stronger luma filter is filters are used only if all the Condition1, Condition2 and Condition 3 are TRUE.

The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.

$$bSidePisLargeBlk = ( ( edge type is vertical and {p}_{0} belongs to CU width >= 32 ) \vert \vert ( edge type is horizontal and {p}_{0} belongs to CU with height >= 32 ) ) ? TRUE : FALSE$$

$$bSideQisLargeBlk = ( ( edge type is vertical and {q}_{0} belongs to CU width >= 32 ) \vert \vert ( edge type is horizontal and {p}_{0} belongs to CU with height >= 32 ) ) ? TRUE : FALSE$$

Based on bSidePisLargeBlk and bSideQisLargeBlk, the condition 1 is defined as follows.

Condition1=(bSidePisLargeBlk| bSidePisLargeBlk)? TRUE: FALSE

Next, if Condition 1 is true, the condition 2 will be further checked. First, the following variables are derived:
dp0, dp3, dq0, dq3 are first derived as in HEVC
if (p side is greater than or equal to 32)

$$dp 0 = ( dp 0 + Abs ( p {5}_{0} - 2 * p {4}_{0} + p {3}_{0} ) + 1 ) ≫ 1$$

$$dp 3 = ( dp 3 + Abs ( p {5}_{3} - 2 * p {4}_{3} + p {3}_{3} ) + 1 ) ≫ 1$$

if (q side is greater than or equal to 32)

$$dq 0 = ( dq 0 + Abs ( q {5}_{0} - 2 * q {4}_{0} + q {3}_{0} ) + 1 ) ≫ 1$$

$$dq 3 = ( dq 3 + Abs ( q {5}_{3} - 2 * q {4}_{3} + q {3}_{3} ) + 1 ) ≫ 1$$

Condition2=(d<β)? TRUE: FALSE

$$where$$

$$d = dp 0 + dq 0 + dp 3 + dq 3.$$

If Condition1 and Condition2 are valid, whether any of the blocks uses sub-blocks is further checked:

```
If (bSidePisLargeBlk)
  {
    If (mode block P == SUBBLOCKMODE)
        Sp =5
      else
        Sp =7
}
else
  Sp = 3
If (bSideQisLargeBlk)
    {
        If (mode block Q == SUBBLOCKMODE)
            Sq =5
          else
            Sq =7
      }
else
    Sq = 3
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
dpq is derived as in HEVC.
sp₃ = Abs( p₃ − p₀ ), derived as in HEVC
    if (p side is greater than or equal to 32)
if(Sp==5)
      sp₃ = ( sp₃ + Abs( p₅ − p₃ ) + 1) >> 1
    else
      sp₃ = ( sp₃ + Abs( p₇ − p₃ ) + 1) >> 1
sq₃ = Abs( q₀ − q₃ ), derived as in HEVC
if (q side is greater than or equal to 32)
  If(Sq==5)
    sq₃ = ( sq₃ + Abs( q₅ − q₃ ) + 1) >> 1
  else
    sq₃ = ( sq₃ + Abs( q₇ − q₃ ) + 1) >> 1.
```

$$As in HEVC ,$$

$$StrongFilterCondition = ( dpq is less than ( β ≫ 2 ) ,$$

$${sp}_{3} + {sq}_{3} is less than ( 3 * β ≫ 5 ) ,$$

$$and$$

$$Abs ( {p}_{0} - {q}_{0} ) is less than ( 5 * {t}_{C} + 1 ) ≫ 1 ) ? TRUE : FALSE .$$

### 2.4.4. Stronger Deblocking Filter for Luma (Designed for Larger Blocks)

Bilinear filter is used when samples at either one side of a boundary belong to a large block. A sample belonging to a large block is defined as when the width>=32 for a vertical edge, and when height>=32 for a horizontal edge.

The bilinear filter is listed below.

Block boundary samples pᵢ for i=0 to Sp-1 and qᵢ for j=0 to Sq-1 (pi and qi are the i-th sample within a row for filtering vertical edge, or the i-th sample within a column for filtering horizontal edge) in HEVC deblocking described above) are then replaced by linear interpolation as follows:

$${p}_{i}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i}$$

$${q}_{j}^{′} = ( {g}_{j} * {Middle}_{s , t} + ( 64 - {g}_{j} ) * {Q}_{s} + 32 ) ≫ 6 ) , clipped to {q}_{j} \pm {tcPD}_{j}$$

where tcPDᵢ and tcPDⱼ term is a position dependent clipping described in Section 2.4.7 and gⱼ, ƒᵢ, Middle_{s,t}, Pₛ and Qₛ are given below:

### 2.4.5. Deblocking Control for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped.

Chroma deblocking is performed when bS is equal to 2, or bS is equal to 1 when a large block boundary is detected. The second and third condition is basically the same as HEVC luma strong filter decision as follows.

In the second condition:
d is then derived as in HEVC luma deblocking.
The second condition will be TRUE when d is less than B.

In the third condition StrongFilterCondition is derived as follows:
dpq is derived as in HEVC.
sp₃=Abs (p₃−p₀), derived as in HEVC.
sq₃=Abs (q₀−q₃), derived as in HEVC.

As in HEVC design, StrongFilterCondition=(dpq is less than (β>>2), sp₃+sq₃ is less than (β>>3), and Abs (p₀−q₀) is less than (5*t_{C}+1)>>1).

### 2.4.6. Strong Deblocking Filter for Chroma

The following strong deblocking filter for chroma is defined:

$${p}_{2}^{′} = ( 3 * {p}_{3} + 2 * {p}_{2} + {p}_{1} + {p}_{0} + {q}_{0} + 4 ) ≫ 3$$

$${p}_{1}^{′} = ( 2 * {p}_{3} + {p}_{2} + 2 * {p}_{1} + {p}_{0} + {q}_{0} + {q}_{1} + 4 ) ≫ 3$$

$${p}_{2}^{′} = ( {p}_{3} + {p}_{2} + {p}_{1} + 2 * {p}_{0} + {q}_{0} + {q}_{1} + {q}_{2} + 4 ) ≫ 3$$

The proposed chroma filter performs deblocking on a 4×4 chroma sample grid.

### 2.4.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

$$Tc 7 = \{ 6 , 5 , 4 , 3 , 2 , 1 , 1 \} ; Tc 3 = \{ 6 , 4 , 2 \} ;$$

$$tcPD = ( Sp == 3 ) ? Tc 3 : Tc 7 ;$$

$$tcQD = ( Sq == 3 ) ? Tc 3 : Tc 7 ;$$

For the P or Q boundaries being filtered with a short symmetrical filter, position dependent threshold of lower magnitude is applied:

$$Tc 3 = \{ 3 , 2 , 1 \} ;$$

Following defining the threshold, filtered p′ᵢ and q′ᵢ sample values are clipped according to tcP and tcQ clipping values:

$${p}_{i}^{″} = Clip 3 ( {p}_{i}^{′} + {tcP}_{i} , {p}_{i}^{′} - tc {P}_{i} , {p}_{i}^{′} ) ;$$

$${q}_{j}^{″} = Clip 3 ( {q}_{j}^{′} + {tcQ}_{j} , {q}_{j}^{′} - {tcQ}_{j} , {q}_{j}^{′} ) ;$$

where p′ᵢ and q′ᵢ are filtered sample values, p″ᵢ and q″ⱼ are output sample value after the clipping and tcPᵢ tcPᵢ are clipping thresholds that are derived from the VVC tc parameter and tcPD and tcQD. The function Clip3 is a clipping function as it is specified in VVC.

### 2.4.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge !=0) {
  if (!(implicitTU && (edge == (64 / 4))))
    if (edge == 2 ∥ edge == (orthogonalLength − 2) ∥ edge == (56 / 4) ∥ edge == (72 / 4))
        Sp = Sq = 2;
      else
        Sp = Sq = 3;
    else
        Sp = Sq = bSideQisLargeBlk ? 5:3
  }
```

Where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 2.5. SAO

The input of SAO is the reconstructed samples after DB. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC and VVC, the region (the unit for SAO parameters signaling) is defined to be a CTU.

Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 135° diagonal, and 45° diagonal.

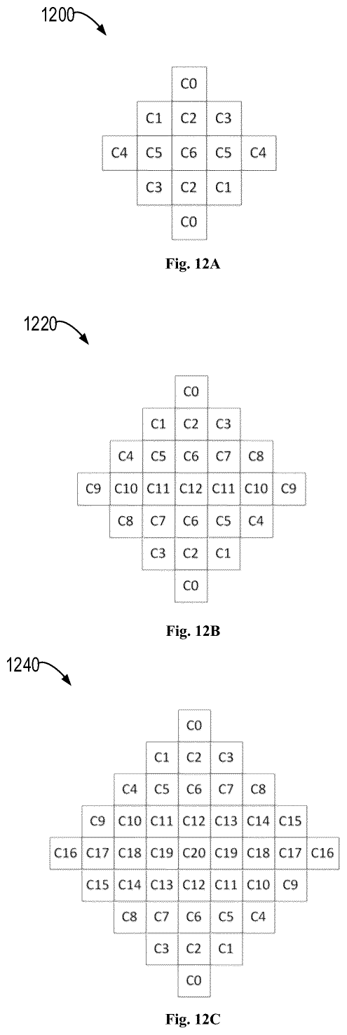

FIG. 11A illustrates an example diagram 1100 showing a 1-D directional pattern for EO sample classification with horizontal (EO1 class=0). FIG. 11B illustrates an example diagram 1120 showing a 1-D directional pattern for EO sample classification with vertical (EO class=1). FIG. 11C illustrates an example diagram 1140 showing a 1-D directional pattern for EO sample classification with 135° diagonal (EO class=2). FIG. 11D illustrates an example diagram 1160 showing a 1-D directional pattern for EO sample classification with 45° diagonal (EO class=3).

For a given EO class, each sample inside the CTB is classified into one of five categories. The current sample value, labeled as “c,” is compared with its two neighbors along the selected 1-D pattern. The classification rules for each sample are summarized in Table 1. Categories 1 and 4 are associated with a local valley and a local peak along the selected 1-D pattern, respectively. Categories 2 and 3 are associated with concave and convex corners along the selected 1-D pattern, respectively. If the current sample does not belong to EO categories 1-4, then it is category 0 and SAO is not applied.

TABLE 3
Sample Classification Rules for Edge Offset

| Category | Condition |
|---|---|
| 1 | c < a and c < b |
| 2 | (c < a && c == b) \|\|(c == a && c < b) |
| 3 | (c > a && c == b) \|\|(c == a && c > b) |
| 4 | c > a && c > b |
| 5 | None of above |

### 2.6. Geometry Transformation-Based Adaptive Loop Filter in JEM

The input of DB is the reconstructed samples after DB and SAO. The sample classification and filtering process are based on the reconstructed samples after DB and SAO.

In the JEM, a geometry transformation-based adaptive loop filter (GALF) with block-based filter adaption is applied. For the luma component, one among 25 filters is selected for each 2×2 block, based on the direction and activity of local gradients.

### 2.6.1. Filter Shape

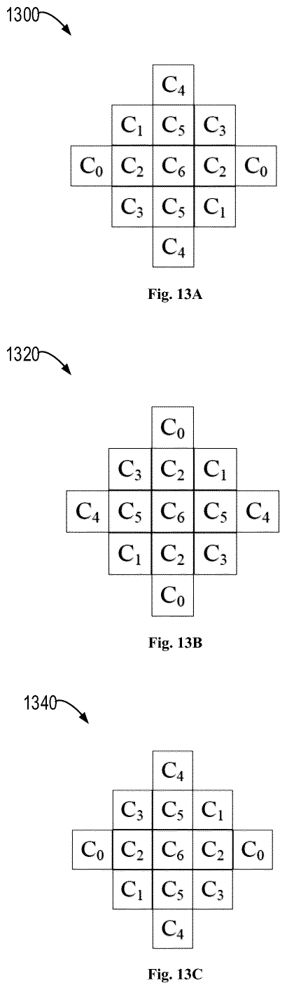

FIG. 12A illustrates an example diagram 1200 showing examples of GALF filter shapes with 5×5 diamond. FIG. 12B illustrates an example diagram 1220 showing examples of GALF filter shapes with 7×7 diamond. FIG. 12C illustrates an example diagram 1240 showing examples of GALF filter shapes with 9×9 diamond.

In the JEM, up to three diamond filter shapes (as shown in FIGS. 12A-12C) can be selected for the luma component. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used.

### 2.6.1.1. Block Classification

Each 2×2 block is categorized into one out of 25 classes. The classification index C is derived based on its directionality D and a quantized value of activity Â, as follows:

$$C = 5 D + Â . \qquad ( 1 )$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert , \qquad ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , \qquad ( 3 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad ( 4 )$$

$${g}_{d 2} = {\sum }_{k = i - 2}^{i + 3} {\sum }_{l = j - 2}^{j + 3} D {2}_{k , l} , D {2}_{k , l} = \vert 2 R ( k , l ) - R ( k - 1 , l - 1 ) - R ( k + 1 , l - 1 ) \vert \qquad ( 5 )$$

Indices i and j refer to the coordinates of the upper left sample in the 2×2 block and R (i, j) indicates a reconstructed sample at coordinate (i, j).

Then D maximum and minimum values of the gradients of horizontal and vertical directions are set as:

$${g}_{h , v}^{max} = max ( {g}_{h} , {g}_{v} ) , \qquad ( 6 )$$

$${g}_{h , v}^{min} = min ( {g}_{h} , {g}_{v} ) ,$$

and the maximum and minimum values of the gradient of two diagonal directions are set as:

$${g}_{d 0 , d 1}^{max} = max ( {g}_{d 0} , {g}_{d 1} ) , \qquad ( 7 )$$

$${g}_{d 0 , d 1}^{min} = min ( {g}_{d 0} , {g}_{d 1} ) ,$$

To derive the value of the directionality D, these values are compared against each other and with two thresholds t₁ and t₂:
Step 1. If both g_{h,v}^{max}≤t₁·g_{h,v}^{min} and g_{d0,d1}^{max}≤t₁·g_{d0,d1}^{min} are true, D is set to 0.
Step 2. If g_{h,v}^{max}/g_{h,v}^{min}>g_{d0,d1}^{max}/g_{d0,d1}^{min}, continue from Step 3; otherwise continue from Step 4.
Step 3. If g_{h,v}^{max}>t₂·g_{h,v}^{min}, D is set to 2; otherwise D is set to 1.
Step 4. If g_{d0,d1}^{max}>t₂·g_{d0,d1}^{min}, D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) . \qquad ( 8 )$$

A is further quantized to the range of 0 to 4, inclusively, and the quantized value is denoted as Â.

For both chroma components in a picture, no classification method is applied, i.e. a single set of ALF coefficients is applied for each chroma component.

### 2.6.1.2. Geometric Transformations of Filter Coefficients

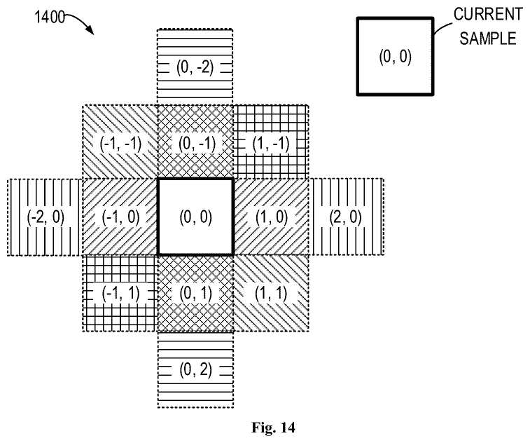

FIG. 13A illustrates an example diagram 1300 showing relative coordinator for the 5×5 diamond filter support (diagonal). FIG. 13B illustrates an example diagram 1320 showing relative coordinator for the 5×5 diamond filter support (vertical flip). FIG. 13C illustrates an example diagram 1340 showing relative coordinator for the 5×5 diamond filter support (rotation).

Before filtering each 2×2 block, geometric transformations such as rotation or diagonal and vertical flipping are applied to the filter coefficients ƒ(k, l), which is associated with the coordinate (k, l), depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , \qquad ( 9 )$$

$$Vertical flip : {f}_{V} ( k , l ) = f ( k , K - l - 1 ) ,$$

$$Rotation : {f}_{R} ( k , l ) = f ( K - l - 1 , k ) .$$

where K is the size of the filter and 0≤k, l≤K−1 are coefficients coordinates, such that location (0,0) is at the upper left corner and location (K−1,K−1) is at the lower right corner. The transformations are applied to the filter coefficients ƒ (k, l) depending on gradient values calculated for that block. The relationship between the transformation and the four gradients of the four directions are summarized in Table 4. FIGS. 12A-12C show the transformed coefficients for each position based on the 5×5 diamond.

TABLE 4
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling. In this case, only an index to one of the reference pictures is signalled, and the stored GALF coefficients of the indicated reference picture are inherited for the current picture.

To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.

Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter. Even when the fixed filter is selected for a given class, the coefficients of the adaptive filter ƒ (k, l) can still be sent for this class in which case the coefficients of the filter which will be applied to the reconstructed image are sum of both sets of coefficients.

The filtering process of luma component can controlled at CU level. A flag is signalled to indicate whether GALF is applied to the luma component of a CU. For chroma component, whether GALF is applied or not is indicated at picture level only.

### 2.6.1.4. Filtering Process

At decoder side, when GALF is enabled for a block, each sample R (i, j) within the block is filtered, resulting in sample value R′(i,j) as shown below, where L denotes filter length, ƒ_{m,n} represents filter coefficient, and ƒ (k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) \qquad ( 10 )$$

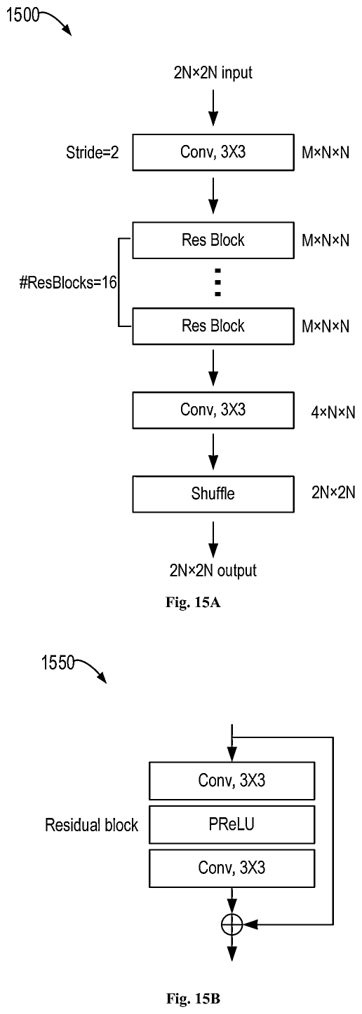

FIG. 14 illustrates an example diagram 1400 showing examples of relative coordinates for the 5×5 diamond filter support. FIG. 14 shows an example of relative coordinates used for 5×5 diamond filter support supposing the current sample's coordinate (i, j) to be (0, 0). Samples in different coordinates filled with the same color are multiplied with the same filter coefficients.

### 2.7. Geometry Transformation-Based Adaptive Loop Filter (GALF) in VVC

### 2.7.1. GALF in VTM-4

In VTM4.0, the filtering process of the Adaptive Loop Filter, is performed as follows:

$$O ( x , y ) = {\sum }_{( i , j )} w ( i , j ) \cdot I ( x + i , y + j ) , \qquad ( 11 )$$

where samples I(x+i, y+j) are input samples, O(x, y) is the filtered output sample (i.e. filter result), and w (i, j) denotes the filter coefficients. In practice, in VTM4.0 it is implemented using integer arithmetic for fixed point precision computations:

$$O ( x , y ) = ( {\sum }_{i = - \frac{L}{2}}^{\frac{L}{2}} {\sum }_{j = - \frac{L}{2}}^{\frac{L}{2}} w ( i , j ) \cdot I ( x + i , y + j ) + 64 ) ≫ 7 , \qquad ( 12 )$$

where L denotes the filter length, and where w (i, j) are the filter coefficients in fixed point precision.

The current design of GALF in VVC has the following major changes compared to that in JEM:
1) The adaptive filter shape is removed. Only 7×7 filter shape is allowed for luma component and 5×5 filter shape is allowed for chroma component.
2) Signaling of ALF parameters in removed from slice/picture level to CTU level.
3) Calculation of class index is performed in 4×4 level instead of 2×2. In addition, sub-sampled Laplacian calculation method for ALF classification is utilized. More specifically, there is no need to calculate the horizontal/vertical/45 diagonal/135 degree gradients for each sample within one block. Instead, 1:2 subsampling is utilized.

### 2.8. Non-Linear ALF in Current VVC

### 2.8.1. Filtering Reformulation

Equation (11) can be reformulated, without coding efficiency impact, in the following expression:

$$O ( x , y ) = I ( x , y ) + {\sum }_{( i , j ) \neq ( 0 , 0 )} w ( i , j ) \cdot ( I ( x + i , y + j ) - I ( x , y ) ) , \qquad ( 13 )$$

where w (i, j) are the same filter coefficients as in equation (11) [excepted w (0, 0) which is equal to 1 in equation (13) while it is equal to 1−Σ_{(i,j)≠(0,0)} w(i,j) in equation (11)].

Using this above filter formula of (13), VVC introduces the non-linearity to make ALF more efficient by using a simple clipping function to reduce the impact of neighbor sample values (I(x+i, y+j)) when they are too different with the current sample value (I(x,y)) being filtered.

More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) ) , \qquad ( 14 )$$

where K (d,b)=min (b, max (−b,d)) is the clipping function, and k (i, j) are clipping parameters, which depends on the (i, j) filter coefficient. The encoder performs the optimization to find the best k (i, j).

In some implementation, the clipping parameters k (i, j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The sets of clipping values are provided in the Table 5. The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 … N ] \} , \qquad ( 15 )$$

$$with$$

$$M = {2}^{10}$$

$$and$$

$$N = 4.$$

Similarly, the Chroma tables of clipping values is obtained according to the following formula:

$${AlfClip}_{C} = \{ round ( A \cdot {( {( \frac{M}{A} )}^{\frac{1}{N - 1}} )}^{N - n} ) for n ∈ 1 … N ] \} , \qquad ( 16 )$$

$$with$$

$$M = {2}^{10} ,$$

$$N = 4$$

$$and$$

$$A = 4.$$

TABLE 5
Authorized clipping values

| | INTRA/INTER tile group |
|---|---|
| LUMA | {1024, 181, 32, 6} |
| CHROMA | {1024, 161, 25, 4} |

The selected clipping values are coded in the “alf_data” syntax element by using a Golomb encoding scheme corresponding to the index of the clipping value in the above Table 5. This encoding scheme is the same as the encoding scheme for the filter index.

### 2.9. Bilateral In-Loop Filter

### 2.9.1. Bilateral Image Filter

Bilateral image filter is a nonlinear filter that smooths the noise while preserving edge structures. The bilateral filtering is a technique to make the filter weights decrease not only with the distance between the samples but also with increasing difference in intensity. This way, over-smoothing of edges can be ameliorated. A weight is defined as

$$w ( Δ x , Δ y , Δ I ) = {e}^{- \frac{Δ {x}^{2} + Δ {y}^{2}}{2 {σ}_{d}^{2}} - \frac{Δ {I}^{2}}{2 {σ}_{r}^{2}}}$$

where Δx and Δy is the distance in the vertical and horizontal and ΔI is the difference in intensity between the samples.

The edge-preserving de-noising bilateral filter adopts a low-pass Gaussian filter for both the domain filter and the range filter. The domain low-pass Gaussian filter gives higher weight to pixels that are spatially close to the center pixel. The range low-pass Gaussian filter gives higher weight to pixels that are similar to the center pixel. Combining the range filter and the domain filter, a bilateral filter at an edge pixel becomes an elongated Gaussian filter that is oriented along the edge and is greatly reduced in gradient direction. This is the reason why the bilateral filter can smooth the noise while preserving edge structures.

### 2.9.2. Bilateral Filter in Video Coding

The bilateral filter in video coding is proposed as a coding tool for the VVC. The filter acts as a loop filter in parallel with the sample adaptive offset (SAO) filter. Both the bilateral filter and SAO act on the same input samples, each filter produces an offset, and these offsets are then added to the input sample to produce an output sample that, after clipping, goes to the next stage. The spatial filtering strength σ_{d} is determined by the block size, with smaller blocks filtered more strongly, and the intensity filtering strength σᵣ is determined by the quantization parameter, with stronger filtering being used for higher QPs. Only the four closest samples are used, so the filtered sample intensity I_{F} can be calculated as

$${I}_{F} = {I}_{C} + \frac{{w}_{A} Δ {I}_{A} + {w}_{B} Δ {I}_{B} + {w}_{L} Δ {I}_{L} + {w}_{R} Δ {I}_{R}}{{w}_{C} + {W}_{A} + {W}_{B} + {W}_{L} + {W}_{R}}$$

where I_{C} denotes the intensity of the center sample, ΔI_{A}=I_{A}−I_{C} the intensity difference between the center sample and the sample above. ΔI_{B}, ΔI_{L} and ΔI_{R} denote the intensity difference between the center sample and that of the sample below, to the left and to the right respectively.

### 2.10. Convolutional Neural Network-Based Loop Filters for Video Coding

### 2.10.1. Convolutional Neural Networks

In deep learning, a convolutional neural network (CNN, or ConvNet) is a class of deep neural networks, most commonly applied to analyzing visual imagery. They have very successful applications in image and video recognition/processing, recommender systems, image classification, medical image analysis, natural language processing.

CNNs are regularized versions of multilayer perceptrons. Multilayer perceptrons usually mean fully connected networks, that is, each neuron in one layer is connected to all neurons in the next layer. The “fully-connectedness” of these networks makes them prone to overfitting data. Typical ways of regularization include adding some form of magnitude measurement of weights to the loss function. CNNs take a different approach towards regularization: they take advantage of the hierarchical pattern in data and assemble more complex patterns using smaller and simpler patterns. Therefore, on the scale of connectedness and complexity, CNNs are on the lower extreme.

CNNs use relatively little pre-processing compared to other image classification/processing algorithms. This means that the network learns the filters that in traditional algorithms were hand-engineered. This independence from prior knowledge and human effort in feature design is a major advantage.

### 2.10.2. Deep Learning for Image/Video Coding

Deep learning-based image/video compression typically has two implications: end-to-end compression purely based on neural networks and traditional frameworks enhanced by neural networks. The first type usually takes an auto-encoder like structure, either achieved by convolutional neural networks or recurrent neural networks. While purely relying on neural networks for image/video compression can avoid any manual optimizations or hand-crafted designs, compression efficiency may be not satisfactory. Therefore, works distributed in the second type take neural networks as an auxiliary, and enhance traditional compression frameworks by replacing or enhancing some modules. In this way, they can inherit the merits of the highly optimized traditional frameworks. For example, a fully connected network for the intra prediction is proposed. In addition to intra prediction, deep learning is also exploited to enhance other modules. For example, the in-loop filters of HEVC with a convolutional neural network is replaced and promising results are achieved. Neural networks are applied to improve the arithmetic coding engine.

### 2.10.3. Convolutional Neural Network Based In-Loop Filtering

In lossy image/video compression, the reconstructed frame is an approximation of the original frame, since the quantization process is not invertible and thus incurs distortion to the reconstructed frame. To alleviate such distortion, a convolutional neural network could be trained to learn the mapping from the distorted frame to the original frame. In practice, training must be performed prior to deploying the CNN-based in-loop filtering.

### 2.10.3.1. Training

The purpose of the training processing is to find the optimal value of parameters including weights and bias. First, a codec (e.g. HM, JEM, VTM, etc.) is used to compress the training dataset to generate the distorted reconstruction frames.

Then the reconstructed frames are fed into the CNN and the cost is calculated using the output of CNN and the groundtruth frames (original frames). Commonly used cost functions include SAD (Sum of Absolution Difference) and MSE (Mean Square Error). Next, the gradient of the cost with respect to each parameter is derived through the back propagation algorithm. With the gradients, the values of the parameters can be updated. The above process repeats until the convergence criteria is met. After completing the training, the derived optimal parameters are saved for use in the inference stage.

### 2.10.3.2. Convolution Process

During convolution, the filter is moved across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.

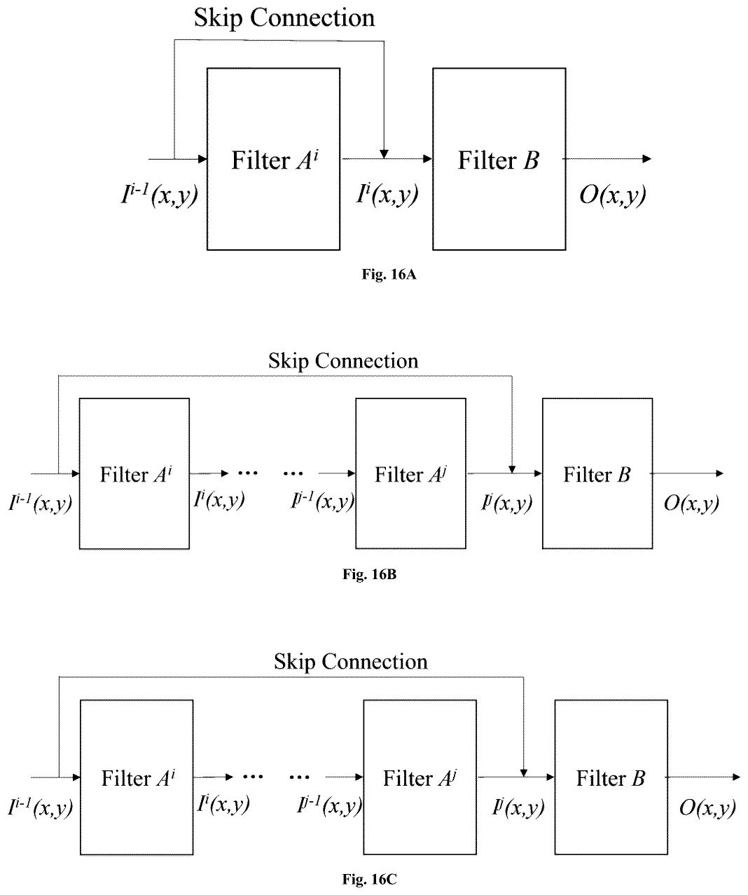

FIG. 15A illustrates an example diagram 1500 showing Architecture of the proposed CNN filter. FIG. 15B illustrates an example diagram 1550 showing a construction of ResBlock (residual block) in the CNN filter. In most of deep convolutional neural networks, residual blocks are utilized as the basic module and stacked several times to construct the final network where in one example, the residual block is obtained by combining a convolutional layer, a ReLU/PRELU activation function and a convolutional layer as shown in FIG. 15B.

### 2.10.3.3. Inference

During the inference stage, the distorted reconstruction frames are fed into CNN and processed by the CNN model whose parameters are already determined in the training stage. The input samples to the CNN can be reconstructed samples before or after DB, or reconstructed samples before or after SAO, or reconstructed samples before or after ALF.

### 3. PROBLEMS

The prior art design of NN filter is applied to generate the reconstruction. Multiple NN filters are selected directly. Therefore, the NN filters could be not fused adaptively.

### 4. DETAILED SOLUTIONS

The detailed embodiments below should be considered as examples to explain general concepts. These embodiments should not be interpreted in a narrow way. Furthermore, these embodiments can be combined in any manner. To solve the above problem, it is proposed to combine or fuse the filtered samples generated by the NN filter and/or Non-NN filters. The present disclosure elaborates how to combine the filters, how to utilize or control filtered samples to generate the adaptive reconstruction.

In the disclosure, an independent filter (ID-Filter) means that the filter is not exactly same with other filters and some parts of the filters are different, such as the input of the filter, the structure of the filter, the parameters of filter, the neural network model of the filter. In one example, the design of ID-Filter is unique and different with the design of other filters. In one example, the inputs of ID-Filter are different when filters share the consistent structure or consistent parameters or consistent model of neural network. ID-Filter can be any kind of filters, including filters without neural network (Non-NN filter) and filters with neural network (NN filter). A Non-NN Filter may be one of deblocking filter (DF), sample adaptive offset (SAO), adaptive loop filter (ALF), etc. A NN filter can be any kind of NN filter, such as a convolutional neural network (CNN) filter. In the following discussion, a NN filter may also be referred to as a CNN filter.

In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick. A father video unit represents a unit larger than the video unit. Typically, a father unit will contain several video units. E.g., when the video unit is CTU, the father unit could be slice, CTU row, multiple CTUs, etc.

The cross-component SAO is denoted as CCSAO. The cross-component ALF is denoted as CCALF. The bilateral in-loop filter is denoted as BIF. The Deblocking filter is denoted as DB.

The width and height of a video unit are denoted as W and H, respectively.

### On Integration of the ID Filter During the Decoding or Encoding Process

1. It is proposed that at least two ID filters may be included in a compatible decoder or encoder.
   a. In one example, ID filters may be used to filter the reconstruction.
      i. In one example, the reconstruction is generated by prediction and residual.
      ii. In one example, the reconstruction is the filtered output signal of other filters.
         1) In one example, the filter may be ID filter or not.
   b. In one example, ID filters may be Non-NN filter and NN filter.
      i. In one example, Non-NN filter may be DB, SAO, BIF, ALF, CCSAO, CCALF.
      ii. In one example, NN filter may be CNN based in-loop filter.
      iii. In one example, the filters may be applied according to the certain or adaptive order.
   c. In one example, ID filters may be NN filters.
      i. In one example, the NN models of NN filters are different.
      ii. In one example, the inputs of the NN models are different when the NN models of NN filters are same.
         1) In one example, the QPs which be used for NN filters are different.
         a. In one example, the models of NN filter are different for different QPs.
         b. In one example, the QPs are the input parameter of models of NN filters.
   d. In one example, ID filters may be Non-NN filters.
      i. In one example, Non-NN filters are DB and SAO.
      ii. In one example, Non-NN filters are DB and ALF.
      iii. In one example, Non-NN filters are SAO and ALF.
      iv. In one example, Non-NN filters are DB and/or SAO and/or BIF and/or CCSAO and/or CCALF and/or ALF.
2. The ID filters may be united to design a new ID filter.
   a. In one example, ID filter ƒ_{A} and ID filter ƒ_{B} may be combined as a new filter ƒ_{C}.
      i. In one example, the ƒ_{C} may be a ID filter which are different with other ID filters, such as ƒ_{A}, ƒ_{B}.
      ii. In one example, ID filter ƒ_{A} and ID filter ƒ_{B} may be same filter.
   b. In one example, DB and SAO may be combined as a new ID filter.
   c. In one example, DB and NN filter may be combined as a new ID filter.
   d. In one example, SAO and NN filter may be combined as a new ID filter.
   e. In one example, BIF and NN filter may be combined as a new ID filter.
   f. In one example, ALF and NN filter may be combined as a new ID filter.
   g. In one example, same or different NN filters may be combined as a new ID filter.
   h. In one example, the number of ID filters in the union process may be N.
      i. In one example, N is 0, 1, 2, 3, 4, etc.
      ii. In one example, N is no less than 2.
      iii. In one example, N may be a positive integer.

### On Combination of the ID Filter During the Decoding or Encoding Process

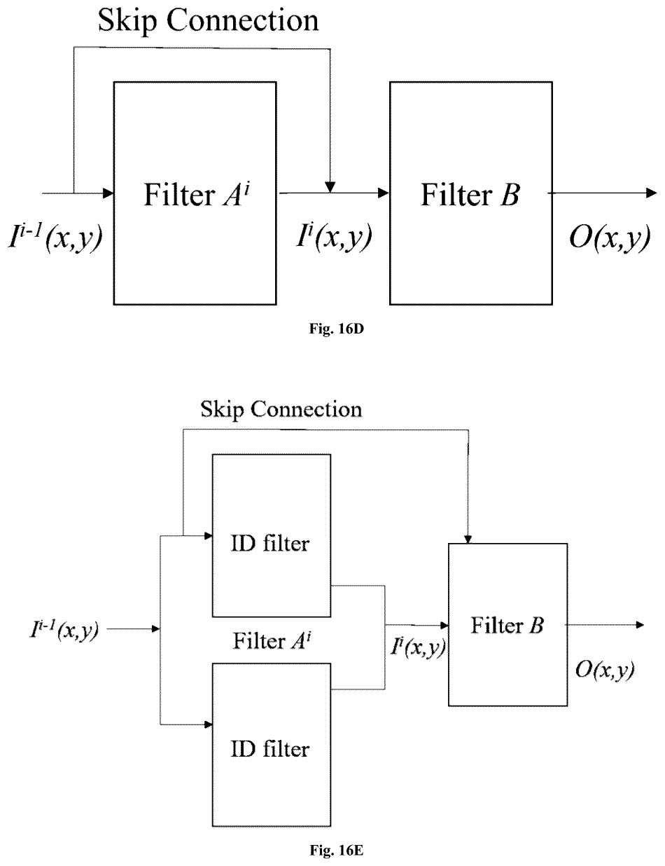

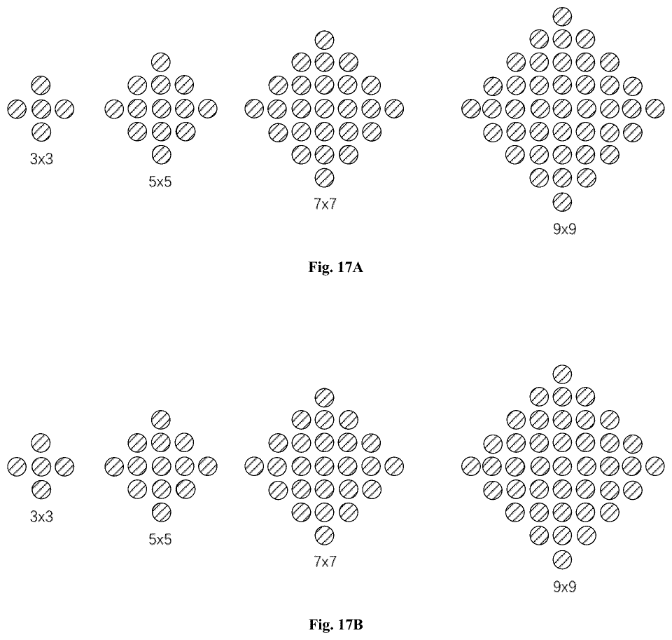

3. The ID filter may be separated with other ID filters.
   a. In one example, the input information of ID filters may be different.
   b. In one example, only finite number N of the filtered reconstruction signals due to ID filters may be remained according to the encoding or decoding rule.
      i. In one example, the rule may be dependent to the coding modes/statistics of the video unit (e.g., prediction modes, qp, temporal layer, slice type, etc.).
      ii. In one example, N is 0, 1, 2, 3, 4, etc.
      iii. In one example, N is no less than 1.
      iv. In one example, N may be a positive integer.
   c. In one example, the ID filter may be separated with other ID filters for part of video units.
   d. In one example, the ID filter may be separated with other ID filters for all of video units.
4. The ID filter may be combined with other ID filters.
   a. In one example, the input information of ID filters may be same.
      i. In one example, the ID filters may be applied parallelly.
      ii. In one example, SAO and BIF may be applied parallelly.
   b. In one example, the output of ID filters may be the input of other filters.
      i. In one example, the filtered reconstruction due to ID filters may be the input information of other filters.
      ii. In one example, NN filter may be applied after DB and/or SAO and/or BIF and/or CCSAO and/or CCALF and/or ALF.
      iii. In one example, a NN filter may be applied after another NN filter.
   c. In one example, the input of ID filters may be the output of other filters.
      i. In one example, the filtered reconstruction due to other filters may be the input signal of ID filters.
      ii. In one example, DB and/or SAO and/or BIF and/or CCSAO and/or CCALF and/or ALF may be prior to NN filter.
      iii. In one example, a NN filter may be prior to another NN filter.
   d. In one example, a skip connection may be applied to ID filters.
      i. In one example, the input of ID filter A and the output of ID filter A may be the input of another ID filter B.
         1) In one example, ID filter A may be a NN filter or DB filter or SAO.
         2) In one example, ID filter A may be a fusion of NN filter and DB filter.
         3) In one example, ID filter B may be ALF and/or CCALF.
      ii. In one example, the input of ID filter A and the output of ID filter A may be the fused by another ID filter B.
         1) In one example, ID filter A may be a NN filter or DB filter or SAO.
         2) In one example, ID filter A may be a fusion of NN filter and DB filter.
         3) In one example, ID filter B may be ALF and/or CCALF.
   e. In one example, a cross-component connection may be applied to ID filters.
      i. In one example, filtering one component C₀ may be depended on filtering another component C₁. In other words, the C₁ ID filter may be used for guiding the C₀ ID filter.
         1) In one example, C₀ may be luma component and C₁ may be chroma component.
         2) In one example, C₀ may be chroma component and C₁ may be luma component.
         3) In one example, C₀ may be Y component and C₁ may be Cb and/or Cr component.
         4) In one example, C₀ may be Cb component and C₁ may be Y and/or Cr component.
         5) In one example, C₀ may be Cr component and C₁ may be Y and/or Cb component.
      ii. In one example, cross-component connection may be dependent to coding samples, coding modes/statistics of the video unit (e.g., prediction modes, qp, temporal layer, slice type, etc.).
         1) In one example, the samples before and/or after C₁ ID filter may be used for C₀ ID filter.
         2) In one example, the information generated by C₁ ID filter may be used for C₀ ID filter.
         a. In one example, information may be boundary strength in DB filter.
         3) In one example, C₀ may be luma component and C₁ may be chroma component.
         4) In one example, C₀ may be chroma component and C₁ may be luma component.
         5) In one example, C₀ may be Y component and C₁ may be Cb and/or Cr component.
         6) In one example, C₀ may be Cb component and C₁ may be Y and/or Cr component.
      iii. In one example, the ID filter may be DB filter.
      iv. In one example, the ID filter may be SAO.
      v. In one example, the ID filter may be ALF.
      vi. In one example, the ID filter may be NN filter.
   f. In one example, the ID filters may be applied before the other filters.
      i. In one example, NN filter may be applied after DB or SAO or ALF.
      ii. In one example, a NN filter may be applied after another NN filter.
   g. In one example, the ID filters may be applied after the other filters.
      i. In one example, DB and/or SAO and/or BIF and/or CCSAO and/or CCALF and/or ALF may be prior to NN filter.
      ii. In one example, a NN filter may be prior to another NN filter.
   h. In one example, the ID filters may be applied according to the certain or adaptive order.
      i. In one example, DB, NN filter, SAO and ALF are applied in sequence.
   i. In one example, the order of applying the ID filters and/or the other filters may be dependent on the coding modes/statistics of the video unit (e.g., prediction modes, qp, temporal layer, slice type, etc.).
   j. In one example, whether to and/or how to utilize the ID filters and/or the other filters may be dependent on the coding modes/statistics of the video unit (e.g., prediction modes, qp, temporal layer, slice type, etc.).
   k. In one example, the ID filter may be combined with other ID filters for part of video units.
   l. In one example, the ID filter may be combined with other ID filters for all of video units.
   m. In one example, the combination of ID filters may be clipped.
      i. In one example, the clipping may be dependent on the coding modes/statistics of the video unit (e.g., prediction modes, qp, temporal layer, slice type, etc.).
      ii. In one example, the clipping may be dependent on the bit depth of input signal and/or internal signal.
5. The ID filter may be combined by a skip connection. Denoting the output of the ID filter Aⁱ is Iⁱ (x,y) and the output of the ID filter B is O(x,y). Such that the input of the ID filter Aⁱ is Iⁱ⁻¹ (x,y).
   a. In one example, N ID filters may be involved in the skip connection.
      i. In one example, N is 0, 1, 2, 3, 4, 5, 6, 7.
      ii. In one example, N may be a positive integer or zero.
   b. In one example, the skip connection may be a short connection.
      i. In one example, one ID filters Aⁱ may be involved in the skip connection. FIG. 16A illustrates a schematic diagram of ID filters Aⁱ involved in the skip connection.
   c. In one example, the skip connection may be a long connection.
      i. In one example, multiple ID filters Aⁱ to A^{j} may be involved in the skip connection. FIG. 16B illustrates a schematic diagram of multiple ID filters Aⁱ to A^{j} may be involved in the skip connection.
         1) In one example, ID filter index i is less or greater than ID filter index j.
         2) In one example, NN filter and/or DB filter may be involved in the skip connection.
         3) In one example, the samples before NN filter and/or DB filter may be additional input of ALF and/or CCALF.
   d. In one example, a skip connection may be applied to multiple ID filters Aⁱ to ID filter A^{j} which are applied in a serial order. FIG. 16C illustrates a schematic diagram of a structure where the skip connection is applied to multiple ID filters Aⁱ to ID filter A^{j} which are applied in a serial order.
      i. In one example, the input of ID filter Aⁱ and the output of ID filter A^{j} may be the input of ID filter B. And ID filter Aⁱ may be applied after/before A^{j}.
         1) In one example, ID filter Aⁱ may be a NN filter or DB filter.
         2) In one example, ID filter Aⁱ may be a fusion of multiple ID filters.
         a. In one example, ID filter Aⁱ may be NN filter and DB filter.
         3) In one example, ID filter A^{j} may be a SAO filter and/or CCSAO.
         4) In one example, ID filter B may be ALF and/or CCALF.
   e. In one example, a skip connection may be applied to one ID filter Aⁱ.
      i. In one example, the input of ID filter Aⁱ and the output of ID filter Aⁱ may be the input of another ID filter B. FIG. 16D illustrate a schematic diagram of a structure where the input of ID filter Aⁱ and the output of ID filter Aⁱ are the input of another ID filter B.
         1) In one example, ID filter Aⁱ may be a NN filter or DB filter or SAO.
         2) In one example, ID filter Aⁱ may be a fusion of multiple ID filters.
         a. In one example, ID filter Aⁱ may be NN filter and DB filter.
         3) In one example, ID filter B may be ALF and/or CCALF.
   f. In one example, the skip connection may be an add and/or subtraction operation with weighting parameters. FIG. 16E illustrates a schematic diagram of a structure where the skip connection is an add and/or subtraction operation with weighting parameters.
      i. In one example, O(x,y)=w₁*f₁ (Iⁱ⁻¹ (x,y))+w₂*f₂ (Iⁱ (x,y)).
         1) In one example, f₁ (*) and/or f₂ (*) may be a K×K filter with weighting parameters.
         2) In one example, w₁ and/or w₂ may be equal to 1.0.
         3) In one example, w₁ and/or w₂ may be equal to 0.0.
         4) In one example, the sum of w₁ and w₂ may be equal to pre-defined value T.
         a. In one example, T may be equal to 1.0.
      ii. In one example, the samples around (x,y) may be used in the function.
   g. In one example, the skip connection may be a concatenation operation.
   h. In one example, the skip connection may be a fusion operation.
   i. In one example, the input of ID filter B may be Iⁱ⁻¹ (x,y) and Iⁱ (x,y).
   j. In one example, the input of ID filter B may be Iⁱ⁻¹ (x, y) and I^{j} (x,y).
   k. In one example, the output O(x,y) of ID filter B may be function ƒ(*, *) of input Iⁱ⁻¹ (x,y) of ID filter Aⁱ and output Iⁱ (x,y) of ID filter Aⁱ.
      i. In one example, ƒ(*,*) may be a add and/or subtraction operation function with weighting parameters.
      ii. In one example, ƒ(*, *) may be a fusion function.
      iii. In one example, ƒ(*, *) may be a concatenation function.
      iv. In one example, O(x,y)=ƒ(Iⁱ⁻¹ (x,y), Iⁱ (x,y)).
      v. In one example, the samples around (x,y) may be used in the function.
         1) In one example, the samples may be located at the pre-defined area. And the sample (x,y) is located at the central position. FIG. 17A illustrates a schematic diagram of samples according to embodiments of the present disclosure.
         a. In one example, the area may be a diamond or rectangle or quadrangle.
         i. In one example, the size of area may be K×K.
         1. In one example, K is 0, 1, 2, 3, 4, 5, 6, 7, 8, 9, 10, 11, 12, 13, 14.
         b. In one example, the number of samples in the area may be L.
         i. In one example, L is 5, 13, 25, 41, 61.
         2) In one example, the parameters may be same for symmetry or diagonal samples.
         3) In one example, the shape and/or number of the samples Iⁱ⁻¹ (x,y) may be different/same with the shape and/or number of the samples I^{j} (x,y).
      vi. In one example, ID filter Aⁱ may be a NN filter or DB filter or SAO.
      vii. In one example, ID filter Aⁱ may be a fusion of multiple ID filters.
         1) In one example, ID filter Aⁱ may be NN filter and DB filter.
      viii. In one example, ID filter B may be ALF and/or CCALF.
      ix. In one example, ID filter Aⁱ may use a 5×5 or 3×3 filters.
      x. In one example, ID filter B may use a 7×7 or 5×5 filters.
   l. In one example, the output O(x,y) of ID filter B may be the fusion of input Iⁱ⁻¹ (x, y) of ID filter Aⁱ and output I^{j} (x,y) of ID filter A^{j}.
      i. In one example, ƒ(*,*) may be a add and/or subtraction operation function with weighting parameters.
      ii. In one example, ƒ(*, *) may be a fusion function.
      iii. In one example, ƒ(*, *) may be a concatenation function.
      iv. In one example, O(x,y)=ƒ(Iⁱ⁻¹ (x,y), I^{j} (x,y)).
      v. In one example, the samples around (x,y) may be used in the function.
         1) In one example, the samples may be located at the pre-defined area. And the sample (x,y) is located at the central position. FIG. 17B illustrates a schematic diagram of samples accord-ing to embodiments of the present disclosure.
         a. In one example, the area may be a diamond or rectangle or quadrangle.
         i. In one example, the size of area may be K×K.
         1. In one example, K is 0, 1, 2, 3, 4, 5, 6, 7, 8, 9, 10, 11, 12, 13, 14.
         b. In one example, the number of samples in the area may be L.
         i. In one example, L is 5, 13, 25, 41, 61.
         2) In one example, the parameters may be same for symmetry or diagonal samples.
         3) In one example, the shape and/or number of the samples Iⁱ⁻¹ (x,y) may be different/same with the shape and/or number of the samples I^{j} (x,y).
      vi. In one example, ID filter Aⁱ may be a NN filter or DB filter.
      vii. In one example, ID filter Aⁱ may be a fusion of multiple ID filters.
         1) In one example, ID filter Aⁱ may be NN filter and DB filter.
      viii. In one example, ID filter Aⁱ may be a SAO filter and/or CCSAO.
      ix. In one example, ID filter B may be ALF and/or CCALF.
   m. In one example, multiple skip connection operations could be combined in any way.
      i. In one example, a skip connection may be applied to ID filter Aⁱ and ID filter B wherein another skip connection may be applied to ID filter A^{j} and ID filter B.
6. Whether to and/or how to utilize the skip connection of ID filters may be dependent on the coding modes/statistics of the video unit (e.g., prediction modes, qp, temporal layer, slice type, etc.).
   a. In one example, it may be dependent on the prediction modes, qp, temporal layer, slice type, etc.).
   b. In one example, it may be dependent on the quantization step.
   c. In one example, it may be dependent on the temporal layer.
   d. In one example, it may be dependent on the slice type.
   e. In one example, it may be dependent on the block size of the video unit.
   f. In one example, it may be dependent on the color components.
   g. In one example, it may be dependent on the signals in the bitstream.
      i. In one example, the signals may be in a sequence and/or a picture and/or a slice and/or a tile and/or a brick and/or a subpicture and/or a CTU/CTB and/or a CTU/CTB row and/or one CU/CB and/or multiple CUs/CBs.
7. The ID filter may be used more than once.
   a. In one example, same ID filters may be connected sequentially.
      i. In one example, the number of ID filters may be N.
         1) In one example, N is 0, 1, 2, 3, 4.
         2) In one example, N is no less than 2.
         3) In one example, N may be a positive integer.
   b. In one example, one ID filter f_{A} is combined with other filter f_{B} and filter f_{C}, separately.
8. Any ID filters may be of the internal stage or part of the filtering processing.
   a. In one example, the filtered samples may be due to the filtering processing.
      i. In one example, the filtered samples may be put into the decoded picture buffer.
      ii. In one example, the filtered samples may be the final display signal.
   b. In one example, filtering processing may be the combination or fusion or selection of multiple groups of ID filters.
      i. In one example, there are one or multiple ID filters in a group of ID filters.
         On usage of the ID filters.
9. Whether to and/or how to utilize the ID filters may be dependent on the coding modes/statistics of the video unit (e.g., prediction modes, qp, temporal layer, slice type, etc.).
   a. In one example, it may be dependent on the prediction modes, qp, temporal layer, slice type, etc.).
   b. In one example, it may be dependent on the quantization step.
   c. In one example, it may be dependent on the temporal layer.
   d. In one example, it may be dependent on the slice type.
   e. In one example, it may be dependent on the block size of the video unit.
   f. In one example, it may be dependent on the color components.
   g. In one example, it may be dependent on the signals in the bitstream.
      i. In one example, the signals may be in a sequence and/or a picture and/or a slice and/or a tile and/or a brick and/or a subpicture and/or a CTU/CTB and/or a CTU/CTB row and/or one CU/CB and/or multiple CUs/CBs.
   h. In one example, the number of ID filters may be N.
      i. In one example, N is 0, 1, 2, 3, 4, 5, 6.
      ii. In one example, N may be dependent on the statistics of the video unit (e.g., prediction modes, qp, temporal layer, slice type, etc.)
         1) In one example, usage of ID filter may be dependent the indicator in a sequence and/or a picture and/or a slice and/or a tile and/or a brick and/or a subpicture and/or a CTU/CTB and/or a CTU/CTB row and/or one CU/CB and/or multiple CUs/CBs.
   i. In one example, ID filters may be a group of filters.
   j. In one example, ID filters may be used in a fusion process.
10. The above methods may be applied to any kind of NN based coding methods.
   a. In one example, the ID filter may be instead by intra prediction/improvement method.
      i. In one example, it may be NN based method and/or Non-NN based method.
   b. In one example, the ID filter may be instead by inter prediction/improvement method.
      ii. In one example, it may be NN based method and/or Non-NN based method.
   c. In one example, they may be applied to the unified NN filtering method (in-loop or post-processing).
   d. In one example, they may be applied to the non-unified NN filtering method (in-loop or post-processing).
   e. In one example, they may be applied to the NN based intra and/or inter method.
   f. In one example, they may be applied to the Non-NN based intra and/or inter method.
   g. In one example, one of ID filters may be the NN based intra/inter method and another one of ID filters may be the Non-NN based intra/inter method.
      i. In one example, they may be fused by the method disclosed above.

### 5. OTHER ASPECTS

### On Fusion of the ID Filters.

11. The ID filters may be fused to generate the samples according to the filtered reconstructions generated by ID filters.
   a. Whether to and/or how to fuse the ID filters may be adaptive.
   b. Whether to and/or how to fuse the ID filters may be dependent on the statistics of the video unit (e.g., prediction modes, qp, temporal layer, slice type, etc.).
   c. Whether to and/or how to fuse the ID filters may be dependent on an equation and/or model.
      i. In one example, the model may be a neural network model.
      ii. In one example, the model may be a linear model.
   d. In one example, fused samples may be put into the decoded picture buffer.
   e. In one example, fused samples may be the final display signal.
   f. In one example, the ID filters may be any type of ID filters.
      i. In one example, the ID filters may be NN filters and/or Non-NN filters.
   g. In one example, the clipping may be applied to the samples due to the fusion of ID filters.
      i. In one example, the clipping may be dependent on the coding modes/statistics of the video unit (e.g., prediction modes, qp, temporal layer, slice type, etc.).
      ii. In one example, the clipping may be dependent on the bit depth of input signal and/or internal signal.
12. Whether to and/or how to fuse the ID filters may be dependent on an equation and/or model.
   a. In one example, linear function may be applied to the presentative filtered samples with ID filters.
      i. In one example, neighboring samples may be involved in the linear function.
         1) In one example, neighboring samples may include adjacent and/or non-adjacent.
   b. In one example, the fusion sample y in video unit may be derived by linear model y=Σaₖ*xₖ+b. Herein, xₖ is the filtered sample due to ID filter fₖ, k is the index of ID filter fₖ, k is from 1 to K. And K, aₖ, and b are parameters.
      i. In one example, the fusion sample y may be final reconstruction.
         1) In one example, the clipped value of fusion sample y may be final reconstruction.
      ii. In one example, b may be equal to zero and y=Σaₖ*xₖ.
      iii. In one example, Σaₖ may be equal to a constant value, such as 1.0, 0.0.
         1) In one example, Σaₖ=1 and y=Σaₖ₋₁*xₖ₋₁+(1−Σaₖ₋₁)*xₖ+b.
      iv. In one example, b=0 and Σaₖ=1 and y=Σaₖ₋₁*xₖ₋₁+(1−Σaₖ₋₁)*xₖ.
      v. In one example, K may be 1, 2, 3, 4, 5.
         1) In one example, K=1 and y=a₁*x₁+b.
         2) In one example, K=2 and y=a₁*x₁+a₂*x₂+b
         3) In one example, K is 3 and y=a₁*x₁+a₂*x₂+a₃*x₃+b
      vi. In one example, K=2 and b=0, such that y=a₁*x₁+a₂*x₂
      vii. In one example, K=2 and Σaₖ=1, such that y=a₁*x₁+ (1−a₁)*x₂+b.
      viii. In one example, K=2 and b=0 and Σaₖ=1, such that y=a₁*x₁+(1−a₁)*x₂.
      ix. In one example, K=3 and b=0, such that y=a₁*x₁+a₂*x₂+a₃*x₃
      x. In one example, K=3 and Σaₖ=1, such that y=a₁*x₁+a₂*x₂+(1−a₁−a₂)*x₃+b
      xi. In one example, K=3 and b=0 and Σaₖ=1, such that y=a₁*x₁+a₂*x₂+ (1−a₁−a₂)*x₃
      xii. In one example, when K=2.
         1) In one example, ID filter f₁ and f₂ are NN filters.
         a. In one example, the model or network structure of ID filter f₁ may be different with the model of ID filter f₂.
         b. In one example, the model or network structure of ID filter f₁ may be a simplified version of the model of ID filter f₂.
         c. In one example, the model of ID filter f₁ may be a simplified version of the model of ID filter f₂.
         d. In one example, the input parameters of ID filter f₁ may be different with that of ID filter f₂.
         i. In one example, the model or network structure of ID filter f₁ may be same with the model of ID filter f₂.
         ii. In one example, the model or network structure of ID filter f₁ may be different with the model of ID filter f₂.
         1. In one example, the difference between f₁ and f₂ may be the training data, such as quality-level indicator.
         iii. In one example, the quality-level indicator as input may be different for ID filter f₁ and f₂.
         iv. In one example, the quality-level indicator disclosed above may be the QPs or lambdas or Constant rate factor (CRF) value or bitrates.
         2) In one example, ID filter f₁ is NN filter and f₂ is DB or SAO or BIF or CCSAO or CCALF or ALF.
         3) In one example, ID filter f₁ is NN filter and f₂ is a group of DB and/or SAO and/or BIF and/or CCSAO and/or CCALF and/or ALF.
      xiii. In one example, when K=3.
         1) In one example, ID filter f₁, f₂ and f₃ are NN filters.
         a. In one example, the models or network structure of ID filter f₁ and/or f₂ and/or f₃ may be different with each other.
         b. In one example, the model or network structure of ID filter f₁ and/or f₂ may be a simplified version of the model of ID filter f₃.
         c. In one example, the model or network structure of ID filter f₁ and/or f₃ may be a simplified version of the model of ID filter f₂.
         d. In one example, the model or network structure of ID filter f₂ and/or f₃ may be a simplified version of the model or network structure of ID filter f₁.
         e. In one example, the input parameters of ID filter f₁ and/or f₂ and/or f₃ may be different with each other.
         i. In one example, the model or network structure of ID filter f₁ and/or f₂ and/or f₃ may be same with each other.
         ii. In one example, the model or network structure of ID filter f₁ and/or f₂ and/or f₃ may be different with each other.
         1. In one example, the difference between f₁ and/or f₂ and/or f₃ may be the training data, such as quality-level indicator.
         iii. In one example, the quality-level indicator as input may be different for ID filter f₁ and/or f₂ and/or f₃.
         iv. In one example, the quality-level indicator disclosed above may be the QPs or lambdas or Constant rate factor (CRF) value or bitrates.
         2) In one example, ID filter f₁ and/or f₂ and/or f₃ may be NN filter or DB or SAO or BIF or CCSAO or CCALF or ALF.
         3) In one example, ID filter f₁ and/or f₂ and/or f₃ may be NN filter or a group of DB and/or SAO and/or BIF and/or CCSAO and/or CCALF and/or ALF.
      xiv. In one example, K and/or aₖ and/or b may be adaptive or constant value or indicated by one or multiple indicators.
      xv. In one example, K and/or aₖ and/or b may be dependent on the coding modes/statistics of the video unit (e.g., prediction modes, qp, temporal layer, slice type, etc.).
      xvi. In one example, K and/or aₖ and/or b may be pre-designed values.
         1) In one example, aₖ may be 1.0, ⅞, ¾, 0.75, ½, 0.5, ¼, 0.25, 0.0.
      xvii. In one example, K and/or aₖ and/or b may be selected from pre-designed values and/or constant values and/or indicators.
   c. In one example, non-linear function may be applied to the presentative filtered samples with ID filters and/or neighboring samples (including adjacent or non-adjacent).
13. Whether to and/or how to construct the candidate list of fusion of ID filters may be dependent on the coding statistics of the video unit (e.g. prediction modes, qp, slice type, etc.).
   a. The number N_{C} of candidate list may be a constant number.
      i. In one example, N_{C} may be 0, 1, 2, 3, 4.
      ii. In one example, N_{C} may be a positive integer.
   b. The number N_{C} of candidate list may be dependent on the number N_{f} of NN filters.
      i. In one example, N_{C} may be equal to N_{f}.
      ii. In one example, N_{C} may be equal to N_{f}+M.
         1) In one example, M may be −1, 0, 1, 2, 3, 4.
         2) In one example, M may be a positive integer.
      iii. In one example, N_{C} may be equal to 2\hat{ }N_{f}.
   c. The number N_{C} of candidate list may be indicated by one or multiple indicators.
   d. One fusion candidate may comprise Nₖ ID filters.
      i. In one example, Nₖ may be 0, 1, 2, 3, 4.
      ii. In one example, Nₖ may be dependent on the number N_{f} of NN filters.
         1) In one example, Nₖ may be equal to N_{f}.
      iii. In one example, Nₖ may be equal to K disclosed above in the linear model.
   e. In one example, there may be 3 NN filters f_{A}, f_{B}, and f_{C}.
      i. In one example, the first fusion candidate mode may be the fusion of F(f_{A}) and F(f_{B}).
      ii. In one example, the second fusion candidate mode may be the fusion of F (f_{B}) and F (f_{C}).
      iii. In one example, the third fusion candidate mode may be the fusion of F(f_{C}) and F (f_{A}).
      iv. In one example, F(f_{X}) disclosed above may be same with f_{X}.
      v. In one example, F (f_{X}) disclosed above may be a simplified version of f_{X}.
      vi. In one example, F (f_{X}) disclosed above may be dependent on the f_{X}.
      vii. In one example, F (f_{X}) disclosed above may be adaptive for different f_{X}.
   f. In one example, the candidate order may be adaptive.
   g. In one example, the candidate order may be dependent on the coding statistics of the video unit (e.g. prediction modes, qp, slice type, etc.).
   h. In one example, the candidate order may be pre-designed.
   i. In one example, one or any of fusion candidates may only comprise NN filters.
   j. In one example, one or any of fusion candidates may comprise NN filters and Non-NN filters.
      i. In one example, Non-NN filter may be DB or SAO or BIF or CCSAO or CCALF or ALF.
      ii. In one example, Non-NN filter may be a group of DB and/or SAO and/or BIF and/or CCSAO and/or CCALF and/or ALF.
         On usage of the fusion results of ID filters.
14. Whether to and/or how to utilize the fusion result of ID filters may be dependent on the coding modes/statistics of the video unit (e.g., prediction modes, qp, temporal layer, slice type, etc.).
   a. In one example, it may be dependent on the prediction modes, qp, temporal layer, slice type, etc.).
   b. In one example, it may be dependent on the quantization step.
   c. In one example, it may be dependent on the temporal layer.
   d. In one example, it may be dependent on the slice type.
   e. In one example, it may be dependent on the block size of the video unit.
   f. In one example, it may be dependent on the color components.
   g. In one example, it may be dependent on the signals in the bitstream.
      i. In one example, the signals may be in a sequence and/or a picture and/or a slice and/or a tile and/or a brick and/or a subpicture and/or a CTU/CTB and/or a CTU/CTB row and/or one CU/CB and/or multiple CUs/CBs.
   h. In one example, the number of ID filters may be N.
      i. In one example, N is 0, 1, 2, 3, 4, 5, 6.
      ii. In one example, N may be dependent on the statistics of the video unit (e.g., prediction modes, qp, temporal layer, slice type, etc.).
         1) In one example, usage of ID filter may be dependent the indicator in a sequence and/or a picture and/or a slice and/or a tile and/or a brick and/or a subpicture and/or a CTU/CTB and/or a CTU/CTB row and/or one CU/CB and/or multiple CUs/CBs.
   i. In one example, ID filters may be one of a group of filters.
   j. In one example, the clipping may be applied to the samples due to the fusion result of ID filters.
      i. In one example, the clipping may be dependent on the coding modes/statistics of the video unit (e.g., prediction modes, qp, temporal layer, slice type, etc.).
      ii. In one example, the clipping may be dependent on the bit depth of input signal and/or internal signal.
   k. In one example, the fusion result may be put into the decoded picture buffer.
   l. In one example, the fusion result may be the final display signal.

### On Simplification of the NN Filter Models in the Fusion Process

15. The models of ID filters in the fusion process may be a simplified version of the models of other ID filters in the fusion process.
   a. In one example, ID filters may be NN filters.
      i. In one example, the depth of the NN filter models may be different.
         1) In one example, the NN filter models used in fusion process may have a shallower depth.
      ii. In one example, the feature maps of the NN filter models may be different.
         1) In one example, the NN filter models used in fusion process may have less feature maps.
      iii. In one example, the number of ResBlock of the NN filter models may be different.
         1) In one example, the number of ResBlock of the NN filter models used in fusion process may be less.
         2) In one example, the number of ResBlock is 1, 2, 3, 4, 5, 6.
      iv. In one example, convolution kernel of the NN filter models may be different.
      v. In one example, the simplified model and normal model of ID filters may be all used in the fusion process.

### On Signalling of the Fusion Parameters.

16. The usage/enabling of fusion of ID filters can be controlled by adding one or more syntax elements in a first level (e.g., sequence level, such as in SPS or sequence header).
   a. One or more syntax elements in a first level may comprise a first flag indicating whether fusion process is enabled.
      i. In one example, fusion process is enabled if the flag is true or 1.
      ii. In one example, fusion process is not enabled if the flag is false or 0.
   b. One or more syntax elements in a first level may comprise a syntax element indicating the number of fusion modes may be used.
      i. In one example, the syntax elements may be signaled only if fusion is enabled.
   c. One or more syntax elements in a first level may comprise a syntax element indicating whether the fusion process to be used in the first level.
   d. One or more syntax elements in a first level may comprise a syntax element indicating whether fusion process can be adaptively/non-adaptive used or selected in a second level.
17. Alternatively, one or more syntax elements at a second level (e.g., picture level, such as in picture header (PH) or PPS, or slice level such as slice header (SH)) may be further signaled. In the following discussion, PH may be replaced by SH.
   a. The syntax elements at the second level may be conditionally signaled
      i. In one example, whether to signal may be according to those signaled in the first level.
   b. One or more syntax elements in a second level may comprise a first flag indicating whether fusion process is enabled in the second level.
   c. One or more syntax elements in a second level may comprise a syntax element indicating the number of fusion modes may be used in the second level.
      i. In one example, the number of fusion modes may be default value.
         1) In one example, the default value may be 0, 1, 2, 3.
      ii. In one example, those may be not signaled.
   d. One or more syntax elements in a second level may comprise a syntax element indicating whether the fusion process to be used in the second level.
   e. One or more syntax elements in a second level may comprise a syntax element indicating the index of the fusion candidates.
      i. In one example, the index of the fusion candidates may be same with the indicator of the index of selecting filters.
      ii. In one example, whether to signal may be according to those indicating the number of fusion modes.
   f. One or more syntax elements in a second level may comprise a syntax element indicating the fusion parameters disclosed above.
      i. One or more syntax element may indicate the number K of filters used in one fusion mode.
      ii. One or more syntax element may indicate whether aₖ is indicated by a direct syntax element or an indirect syntax element (e.g., index of pre-designed values). It is noted as ADP-SE.
      iii. One or more syntax element (SE) may indicate the parameter aₖ.
         1) One or more syntax element may indicate a function of aₖ.
         a. In one example, aₖ may be equal to SE multiply/divided by a factor T.
         i. In one example, T may be equal to 2\hat{ }W.
         1. In one example, W may be a positive integer.
         a. In one example, W may be 0, 2, 4, 6, 8, 10, 12, 14, 16.
         ii. In one example, T may be a positive integer.
         2) In one example, whether to signal may be dependent on the previous ADP-SE.
      iv. One or more syntax element may indicate the index of parameter aₖ.
         1) In one example, there may indicate the index of several pre-designed values for aₖ.
         2) In one example, whether to signal may be dependent on the previous ADP-SE.
      v. One or more syntax element may indicate the offset parameter b.
      vi. In one example, syntax element for each candidate may be different.
   g. One or more syntax elements in a second level may comprise a syntax element indicating whether fusion process can be adaptively/non-adaptive used or selected in a third level.
18. Alternatively, one or more syntax elements at a third level (e.g., Patch/CTU/CTB/block/subpicture/tile/slice/a region containing multiple samples) may be further signaled.
   a. The syntax elements at the third level may be conditionally signaled.
      i. In one example, whether to signal may be according to those signaled in the first or second level.
   b. One or more syntax elements in a third level may comprise a first flag indicating whether fusion process is enabled in the third level.
   c. One or more syntax elements in a third level may comprise a syntax element indicating whether the fusion process to be used in the third level.
   d. One or more syntax elements in a third level may comprise a syntax element indicating the index of the fusion candidates.
      i. In one example, the index of the fusion candidates may be same with the indicator of the index of selecting filters.
      ii. In one example, whether to signal may be according to those indicating the number of fusion modes in second level.
      iii. In one example, whether to signal may be according to those indicating the number of index of the fusion candidates in second level.
   e. One or more syntax elements in a third level may comprise a syntax element indicating the fusion parameters disclosed above.
      i. One or more syntax element may indicate whether to use the parameters in second level or in third level.
      ii. The following syntax elements at the third level may be conditionally signaled.
         1) In one example, whether to signal may be according to those indicating whether to use the parameters in second level or in third level.
      iii. One or more syntax element may indicate the number K of filters used in one fusion mode.
      iv. One or more syntax element may indicate whether aₖ is indicated by a direct syntax element or an indirect syntax element (e.g., index of pre-designed values). It is noted as ADP-SE.
      v. One or more syntax element (SE) may indicate the parameter aₖ.
         1) One or more syntax element may indicate a function of aₖ.
         a. In one example, aₖ may be equal to SE multiply/divided by a factor T.
         i. In one example, T may be equal to 2\hat{ }W.
         1. In one example, W may be a positive integer.
         a. In one example, W may be 0, 2, 4, 6, 8, 10, 12, 14, 16.
         ii. In one example, T may be a positive integer.
         2) In one example, whether to signal may be dependent on the previous ADP-SE.
      vi. One or more syntax element may indicate the index of parameter aₖ.
         1) In one example, there may indicate the index of several pre-designed values for aₖ.
         2) In one example, whether to signal may be dependent on the previous ADP-SE.
      vii. One or more syntax element may indicate the offset parameter b.
   f. In one example, syntax element for each candidate may be different.
19. In one example, any one of syntax elements disclosed above may be set to a default value.
   a. In one example, syntax elements may be not signaled.
   b. In one example, the default value may be −1, 0, 1, 2, 3, 4.
   c. In one example, the syntax element disclosed above is set to a default value only when the syntax element is not signaled.
      i. In one example, the default value may be −1, 0, 1, 2, 3, 4.
20. In one example, syntax elements disclosed above may be signaled by context coding.
21. In one example, syntax elements disclosed above may be signaled by bypass coding.
22. In one example, syntax elements disclosed above may be binarized using fixed length coding, or unary coding, or truncated unary coding, or signed unary coding, or signed truncated unary coding, or truncated binary coding, or k-th exponential golomb coding or any other binarized coding method.
   a. 1) In one example, k may be a positive integer
      i. In one example, k may be equal to 0, 1, 2, 3, 4, 5, 6.
23. In one example, the syntax elements disclosed above may be signaled individually for different color components.
   a. In one example, the syntax elements disclosed above may be signaled only for C color component.
      i. In one example, C may be Y or Cb or Cr color components.
      ii. In one example, C may be R or G or B color components.
      iii. In one example, the information of other components may be indicated by the syntax elements of X color component.
   b. In one example, the syntax elements may be signaled for all available color components.
   c. In one example, the syntax elements may be signaled for Luma color components.
   d. In one example, the syntax elements may be signaled for Chroma color components.
      i. In one example, Cb and Cr may share same syntax elements.
   e. In one example, the syntax elements may be signaled for Y and/or Cb and/or Cr color components.
   f. In one example, the syntax elements may be signaled for R and/or G and/or B color components.
   g. In one example, Luma may indicate Y component.
   h. In one example, Chroma may indicate Cb or Cr component.
   b. In one example, a syntax element may be indexed by the color component.
24. The above methods may be applied to any kind of NN based coding methods.
   h. In one example, the ID filter may be instead by intra prediction/improvement method.
      i. In one example, it may be NN based method and/or Non-NN based method.
   i. In one example, the ID filter may be instead by inter prediction/improvement method.
      ii. In one example, it may be NN based method and/or Non-NN based method.
   j. In one example, they may be applied to the unified NN filtering method (in-loop or post-processing).
   k. In one example, they may be applied to the non-unified NN filtering method (in-loop or post-processing).
   l. In one example, they may be applied to the NN based intra and/or inter method.
   m. In one example, they may be applied to the Non-NN based intra and/or inter method.
   n. In one example, one of ID filters may be the NN based intra/inter method and another one of ID filters may be the Non-NN based intra/inter method.
      i. In one example, they may be fused by the method disclosed above.

### 6. EMBODIMENT

### 6.1. Embodiment #1

In the proposed method, the number of convolutional neural network-based in-loop filtering for slice is three. The number of filters in fusion process is two. The fusion equation is y=a₁*x₁+ (1−a₁)*x₂.

Firstly, a syntax element is signaled to indicate whether to fuse the NN filters. Secondly, a syntax element is signaled to indicate whether to use the pre-designed parameters or signal the a₁ directly when the fusion is enabled. After that, a syntax element is signaled to indicate the value of parameter directly when signal the a₁ directly. Moreover, a syntax element is signaled to indicate the index of pre-designed parameters when using the pre-designed parameters.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. As used herein, the term “an independent filter (ID) filter” may refer to a filter is not exactly same with other filters and some parts of the filters are different, such as the input of the filter, the structure of the filter, the parameters of filter, the neural network model of the filter. In one example, the design of ID-Filter is unique and different with the design of other filters. In one example, the inputs of ID-Filter are different when filters share the consistent structure or consistent parameters or consistent model of neural network. ID-Filter can be any kind of filters, including filters without neural network (non-NN filter) and filters with neural network (NN filter). A Non-NN Filter may be one of deblocking filter (DF), sample adaptive offset (SAO), adaptive loop filter (ALF), etc. A NN filter can be any kind of NN filter, such as a convolutional neural network (CNN) filter. In the following discussion, a NN filter may also be referred to as a CNN filter.

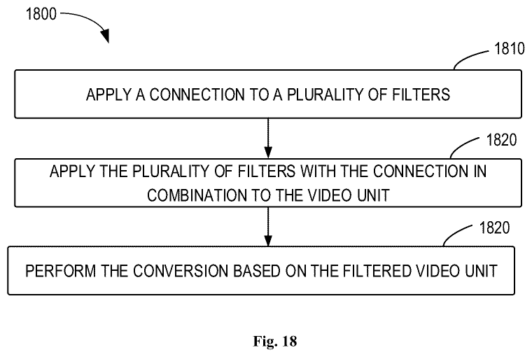

FIG. 18 illustrates a flowchart of a method 1800 for video processing in accordance with embodiments of the present disclosure. The method 1600 is implemented for a conversion between a video unit of a video and a bitstream of the video.

At block 1810, for a conversion between a video unit of a video and a bitstream of the video, a connection is applied to a plurality of filters. In some embodiments, the connection may be a skip connection. Alternatively, the connection may be a cross-component connection.

At block 1820, the plurality of filters with the connection in combination is applied to the video unit. For example, at least two ID filters may be included in a compatible decoder or encoder. Input information or output information of the plurality of filters may be associated with each other. In some embodiments, the plurality of filters may use same input information. For example, the plurality of filters may be applied in parallel. Alternatively, the plurality of filters may be arranged in series and input information and output information of one fil-ter in the plurality of filters may be used as input information of another filter in the plurali-ty of filters. In some other embodiments, output information of the plurality of filters may be selected for further processing. It is noted that the plurality of filters may include any proper number of filters.

At block 1830, the conversion is performed based on the filtered video unit. In some embodiments, the conversion may include encoding the video unit into the bitstream. Alternatively, or in addition, the conversion may include decoding the video unit from the bitstream. Compared with the conventional solution where filters are selected directly, the filters can be adaptively combined for the video unit. In this way, the coding effectiveness and coding efficiency can be improved.

In some embodiments, applying the connection to the plurality of filters may include applying a skip connection to the plurality of filters. In some embodiments, the plurality of filters comprises a first filter and a second filter. In this case, an input of the first filter and an output of the first filter may be input of the second filter. Alternatively, an input of the first filter and an output of the first filter may be combined by the second filter.

In some embodiments, the first filter may be one of: a neural network (NN) filter, a deblocking filter, or a sample adaptive offset (SAO) filter. In some embodiments, the first filter may be a combination of NN filter and deblocking filter. In some embodiments, the second filter may include at least one of: an adaptive loop filter (ALF), or a cross-component ALF (CCALF).

In some embodiments, applying the connection to the plurality of filters may include applying a cross-component connection to the plurality of filters. In some embodiments, filtering a first component is dependent on filtering a second component, or wherein a second filter that filters the second component is used for guiding a first filter that filters the first component. In one example, filtering one component C₀ may be depended on filtering another component C₁. In other words, the C₁ ID filter may be used for guiding the C₀ ID filter.

In some embodiments, the first component is a luma component and the second component is a chroma component. Alternatively, the first component is the chroma component and the second component is the luma component. In some embodiments, the first component is Y component, and the second component is at least one of: Cb component or Cr component. In some embodiments, the first component is Cb component, and the second component is at least one of: Y component or Cr component. In some embodiments, the first component is Cr component, and the second component is at last one of: Y component or Cb component.

In some embodiments, the cross-component connection is dependent on at least one of: coding samples of the video unit, a coding mode of the video unit, or a coding statistic of the video unit. In some embodiments, the coding statistic comprises at least one of: a prediction mode, a quantization parameter (QP), a temporal layer, or a slice type.

In some embodiments, samples before the second filter are used for the first filter. Alternatively, or in addition, samples after the second filter are used for the first filter. In one example, the samples before and/or after C₁ ID filter may be used for C₀ ID filter.

In some embodiments, information generated by the second filter is used for the first filter. In some embodiments, the information is boundary strength in a deblocking filter.

In some embodiments, the first component is a luma component and the second component is a chroma component. Alternatively, the first component is the chroma component and the second component is the luma component. In some embodiments, the first component is Y component, and the second component is at least one of: Cb component or Cr component. Alternatively, the first component is Cb component and the second component is at least one of: Y component or Cr component.

In some embodiments, at least one filter in the plurality of filters may be one of: a deblocking filter, a sample adaptive offset (SAO) filter, an ALF, or a NN filter.

In some embodiments, applying the connection to the plurality of filters may include combining the plurality of filters by a skip connection. For example, the ID filter may be combined by a skip connection. Denoting the output of the ID filter Aⁱ is Iⁱ (x, y) and the output of the ID filter B is O(x,y). Such that the input of the ID filter Aⁱ is Iⁱ⁻¹(x, y).

In some embodiments, a number of filters are involved in the skip connection. In some embodiments, the number of filters involved in the skip connection is a positive integer or zero. In some embodiments, the number of filters involved in the skip connection is 0, 1, 2, 3, 4, 5, 6, or 7.

In some embodiments, the skip connection is a short connection. For example, as shown in FIG. 16A, one filter is involved in the skip connection.

In some other embodiments, the skip connection is a long connection. In some embodiments, a set filters with indexes from i to j are involved in the skip connection, where i and j represent filter indexes and are integer numbers. In one example, as shown in FIG. 16B, multiple ID filters Aⁱ to A^{j} may be involved in the skip connection. In some embodiments, i is less than or greater than j. In one example, ID filter index i is less or greater than ID filter index j.

In some embodiments, at least one of: NN filter or deblocking filter is involved in the skip connection. In some embodiments, samples before at least one of: NN filter or deblocking filter are additional input of at least one of: ALF or CCALF.

In some embodiments, the skip connection may be applied to a set of filters with indexes from i to j which are applied in a serial order. In one example, as shown in FIG. 16C, a skip connection may be applied to multiple ID filters Aⁱ to ID filter A^{j} which are applied in a serial order.

In some embodiments, an input of a first filter and an output of a second filter are an input of a third filter, where the first filter is applied before or after the second filter. In one example, the input of ID filter Aⁱ and the output of ID filter A^{j} may be the input of ID filter B. And ID filter Aⁱ may be applied after/before A^{j}.

In some embodiments, the first filter is a NN filter or deblocking filter. In some embodiments, the first filter is a combination of a set of filters. In one example, ID filter Aⁱ may be a NN filter or DB filter. In some embodiments, the first filter is a combination of NN filter and deblocking filter. In one example, ID filter Aⁱ may be a fusion of multiple ID filters. In one example, ID filter Aⁱ may be NN filter and DB filter. In some embodiments, the second filter is at least one of: a SAO filter or a cross-component SAO (CCSAO) filter. In one example, ID filter A^{j} may be a SAO filter and/or CCSAO.

In some embodiments, the third filter is at least one of: an ALF or a CCALF. In one example, ID filter B may be ALF and/or CCALF.

In some embodiments, the skip connection is applied to a first filter. In one example, a skip connection may be applied to one ID filter Aⁱ.

In some embodiments, an input of the first filter and an output of a second filter are input of a third filter. In one example, as shown in FIG. 16D, the input of ID filter Aⁱ and the output of ID filter Aⁱ may be the input of another ID filter B.

In some embodiments, the first filer is one of: a NN filter, a deblocking filter or a SAO filter. In one example, ID filter Aⁱ may be a NN filter or DB filter or SAO. In some embodiments, the first filter is a combination of a set of filters. In one example, ID filter Aⁱ may be a fusion of multiple ID filters. In some embodiments, the first filter is a combination of NN filter and deblocking filter. In one example, ID filter Aⁱ may be NN filter and DB filter. In some embodiments, the third filter is at least one of ALF or CCALF. In one example, ID filter B may be ALF and/or CCALF.

In some embodiments, the skip connection may be at least one of: an add or subtraction operation with weighting parameters. In one example, as shown in FIG. 16E, the skip connection may be an add and/or subtraction operation with weighting parameters.

In some embodiments, O(x,y)=w₁*f₁ (Iⁱ⁻¹ (x,y))+w₂*f₂ (Iⁱ (x,y)), and where Iⁱ (x,y) represents an output of a filter with index i, Iⁱ⁻¹ (x,y) represents an input of filter with index i, O(x,y) represents an output of a third filter, w₁ and w₂ represent weighting parameters, respectively, and f₁ and f₂ represent functions, respectively.

In some embodiments, at least one of: f₁(*) or f₂ (*) is a K×K filter with weighting parameters, where K is an integer number. In one example, w₁ and/or w₂ may be equal to 1.0. In one example, w₁ and/or w₂ may be equal to 0.0. In some embodiments, a sum of w₁ and w₂ may be equal to a predefined value. In some embodiments, the predefined value is equal to 1.

In some embodiments, samples around (x,y) are used in the functions. In some embodiments, the skip connection is a concatenation operation. In some embodiments, the skip connection is a fusion operation.

In some embodiments, an input of a third filter is I^{j-1} (x,y) and I^{j} (x,y), and where I^{j} (x,y) represents an output of a filter with index j, I^{j-1} (x, y) represents an input of filter with index j. In one example, the input of ID filter B may be Iⁱ⁻¹ (x, y) and I^{j} (x, y).

In some embodiments, an output of a third filer is a function ƒ(*, *) of an input Iⁱ⁻¹ (x, y) of a filter with index i and an output Iⁱ (x, y) of the filter with index i. In one example, the output O(x,y) of ID filter B may be function ƒ(*, *) of input Iⁱ⁻¹ (x, y) of ID filter Aⁱ and output Iⁱ (x, y) of ID filter Aⁱ. In some embodiments, an output of a third filer is a function ƒ(*, *) of an input Iⁱ⁻¹ (x, y) of a filter with index i and an output Iⁱ (x,y) of the filter with index i.

In some embodiments, ƒ(*, *) is at least one of: a add or subtraction operation function with weighting parameters. In some embodiments, ƒ(*, *) may be a fusion function. Alternatively, ƒ(*, *) is a concatenation function.

In some embodiments, O(x,y)=ƒ(Iⁱ⁻¹(x,y), Iⁱ (x,y)). In some embodiments, samples around (x,y) are used in the function. In some embodiments, the samples are located at a predefined area, and a sample (x,y) is located at a central position of the predefined area. In some embodiments, the predefined area is one of: diamond, rectangle or quadrangle. In some embodiments, a size of the predefined area is K×K, where K is an integer number. In some embodiments, K is one of 0, 1, 2, 3, 4, 5, 6, 7, 8, 9, 10, 11, 12, 13, 14. FIG. 17A shows a schematic diagram of samples in the predefined area.

In some embodiments, the number of samples in the predefined area is L, where L is an integer number. In some embodiments, L is one of: 5, 13, 25, 41, 61. In some embodiments, parameters are same of symmetry or diagonal samples.

In some embodiments, a shape of samples Iⁱ⁻¹ (x, y) is different from a shape of samples I^{j} (x, y). In some other embodiments, the shape of samples Iⁱ⁻¹ (x,y) is same as the shape of samples I^{j}(x,y). Alternatively, the number of samples Iⁱ⁻¹ (x, y) is different from the number of samples I^{j}(x, y). In some other embodiments, the number of samples Iⁱ⁻¹ (x, y) is same as the number of samples I^{j}(x,y).

In some embodiments, the filter with index i is one of: NN filter, deblocking filter, or SAO filter. In one example, ID filter Aⁱ may be a NN filter or DB filter or SAO.

In some embodiments, the filter with index i is a combination of a set of filters. In one example, ID filter Aⁱ may be a fusion of multiple ID filters.

In some embodiments, the filter with index i is a combination of NN filter and deblocking filter. In one example, ID filter Aⁱ may be NN filter and DB filter.

In some embodiments, the third filter is at least one of: ALF or CCALF. In one example, ID filter B may be ALF and/or CCALF.

In some embodiments, the filter with index i uses a 5×5 or 3×3 filters. In one example, ID filter Aⁱ may use a 5×5 or 3×3 filters.

In some embodiments, the third filter uses a 7×7 or 5×5 filters. In one example, ID filter B may use a 7×7 or 5×5 filters.

In some embodiments, an output of a third filer is a function ƒ(*, *) of an input Iⁱ⁻¹(x, y) of a filter with index i and an output I^{j}(x,y) of the filter with index j. In one example, the output O(x,y) of ID filter B may be the fusion of input Iⁱ⁻¹ (x, y) of ID filter Aⁱ and output I^{j} (x, y) of ID filter A^{j}.

In some embodiments, ƒ(*, *) is at least one of: a add or subtraction operation function with weighting parameters. In some embodiments, ƒ(*, *) is a fusion function. Alternatively, ƒ(*, *) is a concatenation function. In some embodiments, O(x,y)=ƒ(Iⁱ⁻¹ (x,y), I^{j}(x,y)). In some embodiments, samples around (x,y) are used in the function.

In some embodiments, the samples are located at a predefined area, and a sample (x,y) is located at a central position of the predefined area. In some embodiments, the predefined area is one of: diamond, rectangle or quadrangle.

In some embodiments, a size of the predefined area is K×K, where K is an integer number. In some embodiments, K is one of 0, 1, 2, 3, 4, 5, 6, 7, 8, 9, 10, 11, 12, 13, 14. FIG. 17B shows a schematic diagram of samples in the predefined area.

In some embodiments, the number of samples in the predefined area is L, where L is an integer number. In some embodiments, L is one of: 5, 13, 25, 41, 61.

In some embodiments, parameters are same of symmetry or diagonal samples. In some embodiments, a shape of samples Iⁱ⁻¹ (x,y) is different from a shape of samples I^{j}(x,y). In some embodiments, the shape of samples Iⁱ⁻¹(x,y) is same as the shape of samples I^{j}(x,y). Alternatively, the number of samples Iⁱ⁻¹(x,y) is different from the number of samples I^{j}(x, y). In some other embodiments, the number of samples Iⁱ⁻¹ (x, y) is same as the number of samples I^{j}(x,y).

In some embodiments, the filter with index i is one of: NN filter, deblocking filter, or SAO filter. In one example, ID filter Aⁱ may be a NN filter or DB filter.

In some embodiments, the filter with index i is a combination of a set of filters. In one example, ID filter Aⁱ may be a fusion of multiple ID filters. In some embodiments, the filter with index i is a combination of NN filter and deblocking filter. In one example, ID filter Aⁱ may be NN filter and DB filter.

In some embodiments, the filter with index i is at least one of: a SAO filter or CCSAO filter. In one example, ID filter A^{j} may be a SAO filter and/or CCSAO.

In some embodiments, the third filter is at least one of: ALF or CCALF. In one example, ID filter B may be ALF and/or CCALF.

In some embodiments, a plurality of skip connection operations may be combined. In one example, multiple skip connection operations could be combined in any way.

In some embodiments, the skip connection is applied to a filter with index i and a third filter, and another skip connection is applied to a filter with index j and the third filter. In one example, a skip connection may be applied to ID filter Aⁱ and ID filter B where another skip connection may be applied to ID filter A^{j} and ID filter B.

In some embodiments, whether to and/or an approach of utilizing a skip connection of the plurality of filters is dependent on at least one of: coding samples of the video unit, a coding mode of the video unit, or a coding statistic of the video unit. In some embodiments, whether to and/or the approach of utilizing a skip connection of the plurality of filters is dependent on at least one of: a prediction mode, a quantization parameter (QP), a temporal layer, or a slice type. In some embodiments, whether to and/or the approach of utilizing a skip connection of the plurality of filters is dependent on at least one of: a quantization step, a block size of the video unit, color components, or signals in the bitstream. In some embodiments, the signals may be in at last one of: a sequence, a picture, a slice, a tile, a brick, a subpicture, a coding tree unit (CTU), a coding tree block (CTB), a CTU row, a CTB row, a coding unit (CU), a coding block (CB), a plurality of CUs, or a plurality of CBs.

According to further embodiments of the present disclosure, a non-transitory computer-readable recording medium is provided. The non-transitory computer-readable recording medium stores a bitstream of a video which is generated by a method performed by an apparatus for video processing. The method comprisesapplying a connection to a plurality of filters; applying the plurality of filters with the connection in combination to a video unit of the video; and generating the bitstream based on the filtered video unit.

According to still further embodiments of the present disclosure, a method for storing bitstream of a video is provided. The method comprises: applying a connection to a plurality of filters; applying the plurality of filters with the connection in combination to a video unit of the video; generating the bitstream based on the filtered video unit; and storing the bitstream in a non-transitory computer-readable recording medium.

Implementations of the present disclosure can be described in view of the following clauses, the features of which can be combined in any reasonable manner.

Clause 1. A method of video processing, comprising: applying, for a conversion between a video unit of a video and a bitstream of the video, a connection to a plurality of filters; applying the plurality of filters with the connection in combination to the video unit; and performing the conversion based on the filtered video unit.

Clause 2. The method of clause 1, wherein applying the connection to the plurality of filters comprises: applying a skip connection to the plurality of filters.

Clause 3. The method of clause 1, wherein the plurality of filters comprises a first filter and a second filter, and wherein an input of the first filter and an output of the first filter are input of the second filter, or wherein an input of the first filter and an output of the first filter are combined by the second filter.

Clause 4. The method of clause 3, wherein the first filter is one of: a neural network (NN) filter, a deblocking filter, or a sample adaptive offset (SAO) filter.

Clause 5. The method of clause 3, wherein the first filter is a combination of NN filter and deblocking filter.

Clause 6. The method of clause 3, wherein the second filter comprises at least one of: an adaptive loop filter (ALF), or a cross-component ALF (CCALF).

Clause 7. The method of clause 1, wherein applying the connection to the plurality of filters comprises: applying a cross-component connection to the plurality of filters.

Clause 8. The method of clause 7, wherein filtering a first component is dependent on filtering a second component, or wherein a second filter that filters the second component is used for guiding a first filter that filters the first component.

Clause 9. The method of clause 8, wherein the first component is a luma component and the second component is a chroma component, or wherein the first component is the chroma component and the second component is the luma component.

Clause 10. The method of clause 8, wherein the first component is Y component, and the second component is at least one of: Cb component or Cr component.

Clause 11. The method of clause 8, wherein the first component is Cb component, and the second component is at least one of: Y component or Cr component.

Clause 12. The method of clause 8, wherein the first component is Cr component, and the second component is at last one of: Y component or Cb component.

Clause 13. The method of clause 7, wherein the cross-component connection is dependent on at least one of: coding samples of the video unit, a coding mode of the video unit, or a coding statistic of the video unit.

Clause 14. The method of clause 13, wherein the coding statistic comprises at least one of: a prediction mode, a quantization parameter (QP), a temporal layer, or a slice type.

Clause 15. The method of clause 13, wherein samples before the second filter are used for the first filter, and/or wherein samples after the second filter are used for the first filter.

Clause 16. The method of clause 13, wherein information generated by the second filter is used for the first filter.

Clause 17. Th method of clause 16, wherein the information is boundary strength in a deblocking filter.

Clause 18. The method of clause 13, wherein the first component is a luma component and the second component is a chroma component, or wherein the first component is the chroma component and the second component is the luma component.

Clause 19. The method of clause 13, wherein the first component is Y component and the second component is at least one of: Cb component or Cr component, or wherein the first component is Cb component and the second component is at least one of: Y component or Cr component.

Clause 20. The method of clause 7, wherein at least one filter in the plurality of filters is one of: a deblocking filter, a sample adaptive offset (SAO) filter, an ALF, or a NN filter.

Clause 21. The method of clause 1, wherein applying the connection to the plurality of filters comprises: combining the plurality of filters by a skip connection.

Clause 22. The method of clause 21, wherein a number of filters are involved in the skip connection.

Clause 23. The method of clause 22, wherein the number of filters involved in the skip connection is a positive integer or zero.

Clause 24. The method of clause 22, wherein the number of filters involved in the skip connection is 0, 1, 2, 3, 4, 5, 6, or 7.

Clause 25. The method of clause 21, wherein the skip connection is a short connection.

Clause 26. The method of clause 25, wherein one filter is involved in the skip connection.

Clause 27. The method of clause 21, wherein the skip connection is a long connection.

Clause 28. The method of clause 27, wherein a set filters with indexes from i to j are involved in the skip connection, wherein i and j represent filter indexes and are integer numbers.

Clause 29. The method of clause 28, wherein i is less than or greater than j.

Clause 30. The method of clause 28, wherein at least one of: NN filter or deblocking filter is involved in the skip connection.

Clause 31. The method of clause 28, wherein samples before at least one of: NN filter or deblocking filter are additional input of at least one of: ALF or CCALF.

Clause 32. The method of clause 21, wherein the skip connection is applied to a set of filters with indexes from i to j which are applied in a serial order.

Clause 33. The method of clause 32, wherein an input of a first filter and an output of a second filter are an input of a third filter, wherein the first filter is applied before or after the second filter.

Clause 34. The method of clause 33, wherein the first filter is a NN filter or deblocking filter.

Clause 35. The method of clause 33, wherein the first filter is a combination of a set of filters.

Clause 36. The method of clause 35, wherein the first filter is a combination of NN filter and deblocking filter.

Clause 37. The method of clause 33, wherein the second filter is at least one of: a SAO filter or a cross-component SAO (CCSAO) filter.

Clause 38. The method of clause 33, wherein the third filter is at least one of: an ALF or a CCALF.

Clause 39. The method of clause 21, wherein the skip connection is applied to a first filter.

Clause 40. The method of clause 39, wherein an input of the first filter and an output of a second filter are input of a third filter.

Clause 41. The method of clause 40, wherein the first filer is one of: a NN filter, a deblocking filter or a SAO filter.

Clause 42. The method of clause 40, wherein the first filter is a combination of a set of filters.

Clause 43. The method of clause 42, wherein the first filter is a combination of NN filter and deblocking filter.

Clause 44. The method of clause 40, wherein the third filter is at least one of ALF or CCALF.

Clause 45. The method of clause 21, wherein the skip connection is at least one of: an add or subtraction operation with weighting parameters.

Clause 46. The method of clause 45, wherein O(x,y)=w₁*f₁ (Iⁱ⁻¹ (x, y))+w₂*f₂ (Iⁱ(x,y)), and wherein Iⁱ(x,y) represents an output of a filter with index i, Iⁱ⁻¹ (x,y) represents an input of filter with index i, O(x,y) represents an output of a third filter, w₁ and w₂ represent weighting parameters, respectively, and f₁ and f₂ represent functions, respectively.

Clause 47. The method of clause 46, wherein at least one of: f₁(*) or f₂ (*) is a K×K filter with weighting parameters, wherein K is an integer number.

Clause 48. The method of clause 46, wherein at least one of: w₁ or w₂ is equal to 1, or wherein at least one of: w₁ or w₂ is equal to 0.

Clause 49. The method of clause 46, wherein a sum of w₁ and w₂ is equal to a predefined value.

Clause 50. The method of clause 49, wherein the predefined value is equal to 1.

Clause 51. The method of clause 46, wherein samples around (x,y) are used in the functions.

Clause 52. The method of clause 21, wherein the skip connection is a concatenation operation.

Clause 53. The method of clause 21, wherein the skip connection is a fusion operation.

Clause 54. The method of clause 21, wherein an input of a third filter is Iⁱ⁻¹ (x, y) and Iⁱ(x, y), and wherein Iⁱ(x,y) represents an output of a filter with index i, Iⁱ⁻¹ (x,y) represents an input of filter with index i.

Clause 55. The method of clause 21, wherein an input of a third filter is I^{j-1}(x, y) and I^{j}(x,y), and wherein Iⁱ(x, y) represents an output of a filter with index j, I^{j-1}(x,y) represents an input of filter with index j.

Clause 56. The method of clause 21, wherein an output of a third filer is a function ƒ(*, *) of an input Iⁱ⁻¹(x, y) of a filter with index i and an output Iⁱ(x, y) of the filter with index i.

Clause 57. The method of clause 56, wherein ƒ(*, *) is at least one of: a add or subtraction operation function with weighting parameters.

Clause 58. The method of clause 56, wherein ƒ(*, *) is a fusion function, or wherein ƒ(*, *) is a concatenation function.

Clause 59. The method of clause 56, wherein O(x,y)=ƒ(Iⁱ⁻¹ (x,y), Iⁱ(x,y)).

Clause 60. The method of clause 56, wherein samples around (x,y) are used in the function.

Clause 61. The method of clause 60, wherein the samples are located at a predefined area, and a sample (x,y) is located at a central position of the predefined area.

Clause 62. The method of clause 61, wherein the predefined area is one of: diamond, rectangle or quadrangle.

Clause 63. The method of clause 62, wherein a size of the predefined area is K×K, wherein K is an integer number.

Clause 64. The method of clause 63, wherein K is one of 0, 1, 2, 3, 4, 5, 6, 7, 8, 9, 10, 11, 12, 13, 14.

Clause 65. The method of clause 61, wherein the number of samples in the predefined area is L, wherein L is an integer number.

Clause 66. The method of clause 65, wherein L is one of: 5, 13, 25, 41, 61.

Clause 67. The method of clause 60, wherein parameters are same of symmetry or diagonal samples.

Clause 68. The method of clause 60, wherein a shape of samples Iⁱ⁻¹ (x, y) is different from a shape of samples I^{j}(x,y), or wherein the shape of samples Iⁱ⁻¹ (x,y) is same as the shape of samples I^{j}(x,y), or wherein the number of samples Iⁱ⁻¹ (x,y) is different from the number of samples I^{j}(x, y), or wherein the number of samples Iⁱ⁻¹ (x, y) is same as the number of samples I^{j}(x,y).

Clause 69. The method of clause 56, wherein the filter with index i is one of: NN filter, deblocking filter, or SAO filter.

Clause 70. The method of clause 56, wherein the filter with index i is a combination of a set of filters.

Clause 71. The method of clause 70, wherein the filter with index i is a combination of NN filter and deblocking filter.

Clause 72. The method of clause 56, wherein the third filter is at least one of: ALF or CCALF.

Clause 73. The method of clause 56, wherein the filter with index i uses a 5×5 or 3×3 filters.

Clause 74. The method of clause 56, wherein the third filter uses a 7×7 or 5×5 filters.

Clause 75. The method of clause 21, an output of a third filer is a function ƒ(*, *) of an input Iⁱ⁻¹(x, y) of a filter with index i and an output I^{j}(x, y) of the filter with index j.

Clause 76. The method of clause 75, wherein ƒ(*, *) is at least one of: a add or subtraction operation function with weighting parameters.

Clause 77. The method of clause 75, wherein ƒ(*, *) is a fusion function, or wherein ƒ(*, *) is a concatenation function.

Clause 78. The method of clause 75, wherein O(x, y)=ƒ(Iⁱ⁻¹ (x,y), I^{j}(x,y)).

Clause 79. The method of clause 75, wherein samples around (x,y) are used in the function.

Clause 80. The method of clause 79, wherein the samples are located at a predefined area, and a sample (x,y) is located at a central position of the predefined area.

Clause 81. The method of clause 80, wherein the predefined area is one of: diamond, rectangle or quadrangle.

Clause 82. The method of clause 81, wherein a size of the predefined area is K×K, wherein K is an integer number.

Clause 83. The method of clause 82, wherein K is one of 0, 1, 2, 3, 4, 5, 6, 7, 8, 9, 10, 11, 12, 13, 14.

Clause 84. The method of clause 80, wherein the number of samples in the predefined area is L, wherein L is an integer number.

Clause 85. The method of clause 84, wherein L is one of: 5, 13, 25, 41, 61.

Clause 86. The method of clause 79, wherein parameters are same of symmetry or diagonal samples.

Clause 87. The method of clause 79, wherein a shape of samples Iⁱ⁻¹(x, y) is different from a shape of samples I^{j}(x,y), or wherein the shape of samples Iⁱ⁻¹(x,y) is same as the shape of samples I^{j}(x,y), or wherein the number of samples Iⁱ⁻¹ (x, y) is different from the number of samples I^{j}(x, y), or wherein the number of samples Iⁱ⁻¹ (x, y) is same as the number of samples I^{j}(x,y).

Clause 88. The method of clause 75, wherein the filter with index i is one of: NN filter, deblocking filter, or SAO filter.

Clause 89. The method of clause 75, wherein the filter with index i is a combination of a set of filters.

Clause 90. The method of clause 89, wherein the filter with index i is a combination of NN filter and deblocking filter.

Clause 91. The method of clause 75, wherein the filter with index i is at least one of: a SAO filter or CCSAO filter.

Clause 92. The method of clause 75, wherein the third filter is at least one of: ALF or CCALF.

Clause 93. The method of clause 21, wherein a plurality of skip connection operations is combined.

Clause 94. The method of clause 93, wherein the skip connection is applied to a filter with index i and a third filter, and another skip connection is applied to a filter with index j and the third filter.

Clause 95. The method of clause 1, wherein whether to and/or an approach of utilizing a skip connection of the plurality of filters is dependent on at least one of: coding samples of the video unit, a coding mode of the video unit, or a coding statistic of the video unit.

Clause 96. The method of clause 95, wherein whether to and/or the approach of utilizing a skip connection of the plurality of filters is dependent on at least one of: a prediction mode, a quantization parameter (QP), a temporal layer, or a slice type.

Clause 97. The method of clause 95, wherein whether to and/or the approach of utilizing a skip connection of the plurality of filters is dependent on at least one of: a quantization step, a block size of the video unit, color components, or signals in the bitstream.

Clause 98. The method of clause 97, wherein the signals is in at last one of: a sequence, a picture, a slice, a tile, a brick, a subpicture, a coding tree unit (CTU), a coding tree block (CTB), a CTU row, a CTB row, a coding unit (CU), a coding block (CB), a plurality of CUs, or a plurality of CBs.

Clause 99. The method of any of clauses 1-98, wherein the conversion includes encoding the video unit into the bitstream.

Clause 100. The method of any of clauses 1-98, wherein the conversion includes decoding the video unit from the bitstream.

Clause 101. An apparatus for video processing comprising a processor and a non-transitory memory with instructions thereon, wherein the instructions upon execution by the processor, cause the processor to perform a method in accordance with any of clauses 1-100.

Clause 102. A non-transitory computer-readable storage medium storing instructions that cause a processor to perform a method in accordance with any of clauses 1-100.

Clause 103. A non-transitory computer-readable recording medium storing a bitstream of a video which is generated by a method performed by an apparatus for video processing, wherein the method comprises: applying a connection to a plurality of filters; applying the plurality of filters with the connection in combination to a video unit of the video; and generating the bitstream based on the filtered video unit.

Clause 104. A method for storing a bitstream of a video, comprising: applying a connection to a plurality of filters; applying the plurality of filters with the connection in combination to a video unit of the video; generating the bitstream based on the filtered video unit; and storing the bitstream in a non-transitory computer-readable recording medium.

### Example Device

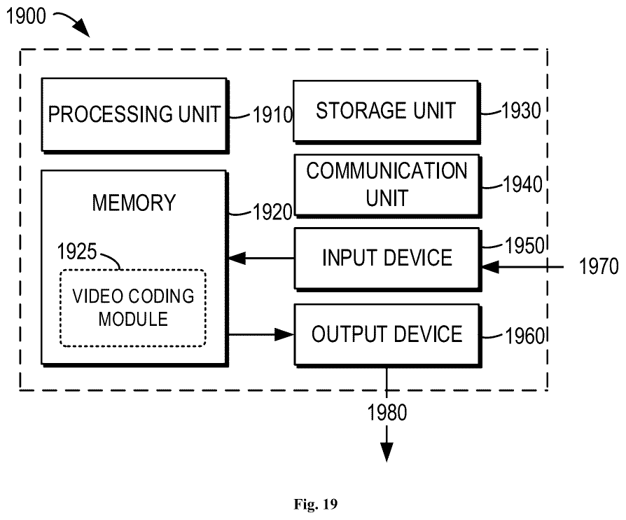

FIG. 19 illustrates a block diagram of a computing device 1900 in which various embodiments of the present disclosure can be implemented. The computing device 1900 may be implemented as or included in the source device 110 (or the video encoder 114 or 200) or the destination device 120 (or the video decoder 124 or 300).

It would be appreciated that the computing device 1900 shown in FIG. 19 is merely for purpose of illustration, without suggesting any limitation to the functions and scopes of the embodiments of the present disclosure in any manner.

As shown in FIG. 19, the computing device 1900 includes a general-purpose computing device 1900.

The computing device 1900 may at least comprise one or more processors or processing units 1910, a memory 1920, a storage unit 1930, one or more communication units 1940, one or more input devices 1950, and one or more output devices 1960.

In some embodiments, the computing device 1900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1900 can support any type of interface to a user (such as “wearable” circuitry and the like).

The processing unit 1910 may be a physical or virtual processor and can implement various processes based on programs stored in the memory 1920. In a multi-processor system, multiple processing units execute computer executable instructions in parallel so as to improve the parallel processing capability of the computing device 1900. The processing unit 1910 may also be referred to as a central processing unit (CPU), a microprocessor, a controller or a microcontroller.

The computing device 1900 typically includes various computer storage medium. Such medium can be any medium accessible by the computing device 1900, including, but not limited to, volatile and non-volatile medium, or detachable and non-detachable medium. The memory 1920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1930 may be any detachable or non-detachable medium and may include a machine-readable medium such as a memory, flash memory drive, magnetic disk or another other media, which can be used for storing information and/or data and can be accessed in the computing device 1900.

The computing device 1900 may further include additional detachable/non-detachable, volatile/non-volatile memory medium. Although not shown in FIG. 19, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1940 communicates with a further computing device via the communication medium. In addition, the functions of the components in the computing device 1900 can be implemented by a single computing cluster or multiple computing machines that can communicate via communication connections. Therefore, the computing device 1900 can operate in a networked environment using a logical connection with one or more other servers, networked personal computers (PCs) or further general network nodes.

The input device 1950 may be one or more of a variety of input devices, such as a mouse, keyboard, tracking ball, voice-input device, and the like. The output device 1960 may be one or more of a variety of output devices, such as a display, loudspeaker, printer, and the like. By means of the communication unit 1940, the computing device 1900 can further communicate with one or more external devices (not shown) such as the storage devices and display device, with one or more devices enabling the user to interact with the computing device 1900, or any devices (such as a network card, a modem and the like) enabling the computing device 1900 to communicate with one or more other computing devices, if required. Such communication can be performed via input/output (I/O) interfaces (not shown).

In some embodiments, instead of being integrated in a single device, some or all components of the computing device 1900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1900 may be used to implement video encoding/decoding in embodiments of the present disclosure. The memory 1920 may include one or more video coding modules 1925 having one or more program instructions. These modules are accessible and executable by the processing unit 1910 to perform the functionalities of the various embodiments described herein.

In the example embodiments of performing video encoding, the input device 1950 may receive video data as an input 1970 to be encoded. The video data may be processed, for example, by the video coding module 1925, to generate an encoded bitstream. The encoded bitstream may be provided via the output device 1960 as an output 1980.

In the example embodiments of performing video decoding, the input device 1950 may receive an encoded bitstream as the input 1970. The encoded bitstream may be processed, for example, by the video coding module 1925, to generate decoded video data. The decoded video data may be provided via the output device 1960 as the output 1980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1. A method of video processing, comprising:
applying, for a conversion between a video unit of a video and a bitstream of the video, a connection to a plurality of filters;
applying the plurality of filters with the connection in combination to the video unit; and
performing the conversion based on the filtered video unit.

2. The method of claim 1, wherein applying the connection to the plurality of filters comprises:
applying a skip connection to the plurality of filters, or
applying a cross-component connection to the plurality of filters.

3. The method of claim 2, wherein filtering a first component is dependent on filtering a second component, or wherein a second filter that filters the second component is used for guiding a first filter that filters the first component, and/or
wherein the cross-component connection is dependent on at least one of: coding samples of the video unit, a coding mode of the video unit, or a coding statistic of the video unit, and/or
wherein at least one filter in the plurality of filters is one of: a deblocking filter, a sample adaptive offset (SAO) filter, an ALF, or a NN filter.

4. The method of claim 3, wherein the first component is a luma component and the second component is a chroma component, or wherein the first component is the chroma component and the second component is the luma component, and/or
wherein the first component is Y component, and the second component is at least one of: Cb component or Cr component, and/or
wherein the first component is Cb component, and the second component is at least one of: Y component or Cr component, and/or
wherein the first component is Cr component, and the second component is at last one of: Y component or Cb component, and/or
wherein the coding statistic comprises at least one of: a prediction mode, a quantization parameter (QP), a temporal layer, or a slice type, and/or
wherein samples before the second filter are used for the first filter, and/or
wherein samples after the second filter are used for the first filter, and/or
wherein information generated by the second filter is used for the first filter, and/or
wherein the first component is a luma component and the second component is a chroma component, or wherein the first component is the chroma component and the second component is the luma component, and/or
wherein the first component is Y component and the second component is at least one of: Cb component or Cr component, or
wherein the first component is Cb component and the second component is at least one of: Y component or Cr component.

5. The method of claim 1, wherein the plurality of filters comprises a first filter and a second filter, and
wherein an input of the first filter and an output of the first filter are input of the second filter, or
wherein an input of the first filter and an output of the first filter are combined by the second filter, and/or
wherein the first filter is one of: a neural network (NN) filter, a deblocking filter, or a sample adaptive offset (SAO) filter, and/or wherein the first filter is a combination of NN filter and deblocking filter, and/or wherein the second filter comprises at least one of: an adaptive loop filter (ALF), or a cross-component ALF (CCALF).

6. The method of claim 1, wherein applying the connection to the plurality of filters comprises:
combining the plurality of filters by a skip connection.

7. The method of claim 6, wherein a number of filters are involved in the skip connection, and/or
wherein the skip connection is a short connection, and/or
wherein the skip connection is a long connection, and/or
wherein the skip connection is applied to a set of filters with indexes from i to j which are applied in a serial order, and/or
wherein the skip connection is applied to a first filter, and/or
wherein the skip connection is at least one of: an add or subtraction operation with weighting parameters, and/or
wherein the skip connection is a concatenation operation, and/or
wherein the skip connection is a fusion operation, and/or
wherein an input of a third filter is Ii-1(x,y) and Ii(x,y), and wherein Ii(x,y) represents an output of a filter with index i, Ii-1(x,y) represents an input of filter with index i, and/or
wherein an input of a third filter is Ij-1(x,y) and Ij(x,y), and wherein Ij(x,y) represents an output of a filter with index j, Ij-1(x,y) represents an input of filter with index j, and/or
wherein an output of a third filer is a function f(*,*) of an input Ii-1(x,y) of a filter with index i and an output Ii(x,y) of the filter with index i, and/or
wherein an output of a third filer is a function f(*, *) of an input Ii-1(x,y) of a filter with index i and an output Ij(x,y) of the filter with index j, and/or
wherein a plurality of skip connection operations is combined.

8. The method of claim 7, wherein the number of filters involved in the skip connection is a positive integer or zero, and/or
wherein the number of filters involved in the skip connection is 0, 1, 2, 3, 4, 5, 6, or 7, and/or
wherein one filter is involved in the skip connection, and/or
wherein a set filters with indexes from i to j are involved in the skip connection, wherein i and j represent filter indexes and are integer numbers, and/or
wherein i is less than or greater than j, and/or
wherein at least one of: NN filter or deblocking filter is involved in the skip connection, and/or
wherein samples before at least one of: NN filter or deblocking filter are additional input of at least one of: ALF or CCALF, and/or
wherein an input of a first filter and an output of a second filter are an input of a third filter, the first filter is applied before or after the second filter, and/or
wherein the skip connection is applied to a filter with index i and a third filter, and another skip connection is applied to a filter with index j and the third filter, and/or
wherein an input of the first filter and an output of a second filter are input of a third filter, and/or wherein O(x,y)=w1*f1 (Ii-1(x,y))+w2*f2 (Ii (x,y)), and wherein Ii(x,y) represents an output of a filter with index i, Ii-1(x,y) represents an input of filter with index i, O(x,y) represents an output of a third filter, w1 and w2 represent weighting parameters, respectively, and f1 and f2 represent functions, respectively.

9. The method of claim 8, wherein the first filter is a NN filter or deblocking filter, and/or
wherein the first filter is a combination of a set of filters, and/or
wherein the second filter is at least one of: a SAO filter or a cross-component SAO (CCSAO) filter, and/or
wherein the third filter is at least one of: an ALF or a CCALF, and/or
wherein the first filer is one of: a NN filter, a deblocking filter or a SAO filter, and/or
wherein the first filter is a combination of a set of filters, and/or
wherein the third filter is at least one of ALF or CCALF, and/or
wherein at least one of: f1 (*) or f2 (*) is a K×K filter with weighting parameters, wherein K is an integer number, wherein at least one of: w1 or w2 is equal to 1, or wherein at least one of: w1 or w2 is equal to 0, and/or
wherein a sum of w1 and w2 is equal to a predefined value, and/or
wherein samples around (x,y) are used in the functions.

10. The method of claim 9, wherein the first filter is a combination of NN filter and deblocking filter, and/or
wherein the predefined value is equal to 1.

11. The method of claim 7, wherein f(*,*) is at least one of: a add or subtraction operation function with weighting parameters, and/or
wherein f(*,*) is a fusion function, or f(*,*) is a concatenation function, and/or
wherein O(x,y)=f(Ii-1(x,y), Ii (x,y)), and/or
wherein samples around (x,y) are used in the function, and/or
wherein the filter with index i is one of: NN filter, deblocking filter, or SAO filter, and/or
wherein the filter with index i is a combination of a set of filters, and/or
wherein the third filter is at least one of: ALF or CCALF, and/or
wherein the filter with index i uses a 5×5 or 3×3 filters, and/or
wherein the third filter uses a 7×7 or 5×5 filters.

12. The method of claim 11, wherein the samples are located at a predefined area, and a sample (x,y) is located at a central position of the predefined area, and/or
wherein parameters are same of symmetry or diagonal samples, and/or
wherein a shape of samples Ii-1(x,y) is different from a shape of samples Ij(x,y), or
wherein the shape of samples Ii-1(x,y) is same as the shape of samples Ij(x,y), or
wherein the number of samples Ii-1(x,y) is different from the number of samples Ij(x,y), or
wherein the number of samples Ii-1(x,y) is same as the number of samples Ij(x,y).

13. The method of claim 11, wherein the predefined area is one of: diamond, rectangle or quadrangle, and/or
wherein the number of samples in the predefined area is L, wherein L is an integer number.

14. The method of claim 7, wherein f(*,*) is at least one of: a add or subtraction operation function with weighting parameters, or
wherein f(*,*) is a fusion function, or f(*,*) is a concatenation function, and/or
wherein O(x,y)=f(Ii-1(x,y), Ij(x,y)), and/or
wherein samples around (x,y) are used in the function, and/or
wherein the filter with index i is one of: NN filter, deblocking filter, or SAO filter, and/or
wherein the filter with index i is a combination of a set of filters, and/or
wherein the filter with index i is at least one of: a SAO filter or CCSAO filter, and/or
wherein the third filter is at least one of: ALF or CCALF.

15. The method of claim 14, wherein the samples are located at a predefined area, and a sample (x,y) is located at a central position of the predefined area, and/or
wherein parameters are same of symmetry or diagonal samples, and/or
wherein a shape of samples Ii-1(x,y) is different from a shape of samples Ij(x,y), or
wherein the shape of samples Ii-1(x,y) is same as the shape of samples Ij(x,y), or
wherein the number of samples Ii-1(x,y) is different from the number of samples Ij(x,y), or
wherein the number of samples Ii-1(x,y) is same as the number of samples Ij(x,y).

16. The method of claim 1, wherein the conversion includes encoding the video unit into the bitstream.

17. The method of claim 1, wherein the conversion includes decoding the video unit from the bitstream.

18. An apparatus for video processing comprising a processor and a non-transitory memory with instructions thereon, wherein the instructions upon execution by the processor, cause the processor to:
apply, for a conversion between a video unit of a video and a bitstream of the video, a connection to a plurality of filters;
apply the plurality of filters with the connection in combination to the video unit; and
perform the conversion based on the filtered video unit.

19. A non-transitory computer-readable storage medium storing instructions that cause a processor to:
apply, for a conversion between a video unit of a video and a bitstream of the video, a connection to a plurality of filters;
apply the plurality of filters with the connection in combination to the video unit; and
perform the conversion based on the filtered video unit.

20. A non-transitory computer-readable recording medium storing a bitstream of a video which is generated by a method performed by an apparatus for video processing, wherein the method comprises:
applying a connection to a plurality of filters;
applying the plurality of filters with the connection in combination to a video unit of the video; and
generating the bitstream based on the filtered video unit.
